(19) United States
(12) Patent Application Publication
(10) Pub. No.: US 2017/0255324 A1
(43) Pub. Date: Sep. 7, 2017

(54) CARD TYPE DEVICE

(71) Applicant: Japan Display Inc., Tokyo (JP)

(72) Inventors: Shinichiro OKA, Tokyo (JP); Hiroshi MIZUHASHI, Tokyo (JP); Shinya IUCHI, Tokyo (JP); Yoshitoshi KIDA, Tokyo (JP); Shinichi TAKAYAMA, Tokyo (JP); Takenori HIROTA, Tokyo (JP); Yosuke HYODO, Tokyo (JP); Takuma NISHINOHARA, Tokyo (JP); Yasukazu KIMURA, Tokyo (JP); Hajime YAMAGUCHI, Tokyo (JP)

(21) Appl. No.: 15/435,610

(22) Filed: Feb. 17, 2017

(30) Foreign Application Priority Data
Mar. 2, 2016 (JP) 2016-039754

(51) Int. Cl. G06F 3/041

(52) U.S. Cl. CPC G06F 3/0416; G06F 3/0412; G06F 2203/04102

(57) ABSTRACT

A card type device includes a base having flexibility and a display having flexibility arranged on the base. A first touch sensor arranged on a first surface of the base or the display, a second touch sensor arranged on a second surface of the base or the display, the second surface being on the opposite side of the first surface, and a control circuit connected to the first touch sensor and the second touch sensor may be further provided.

### CROSS REFERENCE TO RELATED APPLICATIONS

This application is based upon and claims the benefit of priority from the prior Japanese Patent Application No. 2016-039754, filed on Mar. 2, 2016, the entire contents of which are incorporated herein by reference.

### FIELD

The present invention is related to a card type device. In particular, the present invention is related to a card type device attached with a display device having flexibility.

### BACKGROUND

A card type device is widely used as a credit card or an authentication card for company employees and the like. A storage element is arranged in the card type device and unique data of the card type device is stored in the storage element. Authentication of the card type device is carried out by reading the unique data stored in the storage element.

Although a magnetic sheet storing data using magnetism is conventionally used as a storage element of a card type device, a semiconductor integrated circuit (IC chip) is recently being used. Not only can an IC chip store a large amount of data compared to a magnetic sheet, but the IC chip can also analyze external instruction signals and perform calculation processes. A card type device mounted with an IC chip is called a smart card.

A conventional card type device and smart card are both formed by a resin flat plate. Basic data of such cards is displayed by engraving or printing on the resin flat plate (for example, Japanese Laid Open Patent Publication 2003-099737).

In the smart card illustrated in Japanese Laid Open Patent Publication 2003-099737, the basic data displayed on the card cannot be changed. In addition, since basic data is normally displayed, there is a possibility of data being stolen by others with bad intentions.

### SUMMARY

A card type device according to one embodiment of the present invention includes a base having flexibility and a display having flexibility arranged on the base. A first touch sensor arranged on a first surface of the base or the display, a second touch sensor arranged on a second surface of the base or the display, the second surface being on the opposite side of the first surface, and a control circuit connected to the first touch sensor and the second touch sensor may be further provided.

### BRIEF DESCRIPTION OF DRAWINGS

FIG. 1 is a planar view diagram showing an external appearance of a card type device related to one embodiment of the present invention;

FIG. 2 is a planar view diagram showing a structure of card type device related to one embodiment of the present invention;

FIG. 3A is a cross-sectional diagram of the line A-A′ of a card type device related to one embodiment of the present invention;

FIG. 3B is a cross-sectional diagram of the line A-A′ of a card type device related to a modified example of one embodiment of the present invention;

FIG. 4 is a planar view diagram showing a structure of card type device related to one embodiment of the present invention;

FIG. 5 is a cross-sectional diagram of the line B-B′ of a card type device related to one embodiment of the present invention;

FIG. 6 is block diagram showing a functional structure of a control circuit of a card type device related to one embodiment of the present invention;

FIG. 7 is a flowchart showing an operation of a card type device related to one embodiment of the present invention;

FIG. 8 is a diagram for explaining an operation of a card type device related to one embodiment of the present invention;

FIG. 9 is a diagram for explaining a user authentication method of a card type device related to one embodiment of the present invention;

FIG. 10 is a diagram for explaining a user authentication method of a card type device related to one embodiment of the present invention;

FIG. 11 is a planar view diagram showing a structure of a card type device related to one embodiment of the present invention;

FIG. 12 is a cross-sectional diagram of the line C-C′ of a card type device related to one embodiment of the present invention;

FIG. 13 is a planar view diagram showing a structure of a card type device related to one embodiment of the present invention;

FIG. 14 is a cross-sectional diagram of the line D-D′ of a card type device related to one embodiment of the present invention;

FIG. 15 is a diagram for explaining an operation of a card type device related to one embodiment of the present invention;

FIG. 16 is block diagram showing a functional structure of a control circuit of a card type device related to one embodiment of the present invention;

FIG. 17 is block diagram showing a functional structure of a control circuit of a card type device related to a modified example of one embodiment of the present invention;

FIG. 18 is a flowchart showing an operation of a card type device related to one embodiment of the present invention;

FIG. 19 is a planar view diagram showing a structure of a card type device related to one embodiment of the present invention;

FIG. 20 is a planar view diagram showing a pixel layout in a display region of a card type device related to one embodiment of the present invention;

FIG. 21A is a planar view diagram showing a pixel layout in a display region of a card type device related to a modified example of one embodiment of the present invention;

FIG. 21B is a planar view diagram showing a pixel layout in a display region of a card type device related to a modified example of one embodiment of the present invention;

FIG. 22 is a planar view diagram showing a structure of a card type device related to one embodiment of the present invention;

FIG. 23 is a cross-sectional diagram of the line E-E′ of a card type device related to one embodiment of the present invention;

FIG. 24 is a cross-sectional diagram of the line E-E′ of a card type device related to a modified example of one embodiment of the present invention;

FIG. 25 is a planar view diagram showing a structure of a card type device related to one embodiment of the present invention;

FIG. 26 is a cross-sectional diagram of the line F-F′ of a card type device related to one embodiment of the present invention;

FIG. 27 is a planar view diagram showing a structure of a card type device related to one embodiment of the present invention;

FIG. 28 is a planar view diagram showing a structure of a card type device related to one embodiment of the present invention;

FIG. 29 is block diagram showing a functional structure of a feed circuit of a card type device related to one embodiment of the present invention;

FIG. 30 is a flowchart showing an operation of a card type device related to one embodiment of the present invention;

FIG. 31 is a planar view diagram showing a layout of unit pixels in a display region of a card type device related to one embodiment of the present invention;

FIG. 32 is a cross-sectional diagram along the line G-G′ of a layout of unit pixels in a display region of a card type device related to one embodiment of the present invention;

FIG. 33 is a cross-sectional diagram along the line G-G′ of a layout of unit pixels in a display region of a card type device related to a modified example of one embodiment of the present invention;

FIG. 34 is a diagram showing an application example of a card type device related to one embodiment of the present invention;

FIG. 35 is a diagram showing an application example of a card type device related to one embodiment of the present invention;

FIG. 36 is a diagram showing an application example of a card type device related to one embodiment of the present invention; and

FIG. 37 is a cross-sectional diagram of the line A-A′ of a card type device related to one embodiment of the present invention.

### DESCRIPTION OF EMBODIMENTS

Each embodiment of the present invention is explained below while referring to the diagrams. Furthermore, the disclosure is merely an example and a person ordinarily skilled in the art could easily conceive of appropriate modifications while maintaining the concept of the invention and such modifications are naturally contained within the scope of the present invention. Although the width, thickness and shape of each component are shown schematically compared to their actual form in order to better clarify explanation, the drawings are merely an example and should not limit an interpretation of the present invention. In addition, in the specification and each drawing, the same reference symbols are attached to similar elements and elements that have been mentioned in previous drawings, and therefore a detailed explanation may be omitted where appropriate.

In addition, although the terms upper and lower are used for convenience of explanation, the vertical relationship between a first member and a second member may be arranged to be the reverse of the drawings for example. In addition, the expression second member above a first member for example, merely explains the vertical relationship between the first member and second member as described above and other members may also be arranged between the first member and second member. In addition, even in the case where a second member is arranged below a first member in the drawings, in the case where the second member is formed above the first member in a manufacturing process, this may sometimes be expressed as the second member above the first member. The embodiments herein aim to provide a card type device which can change display data.

### First Embodiment

### [External Appearance of a Card Type Device 10]

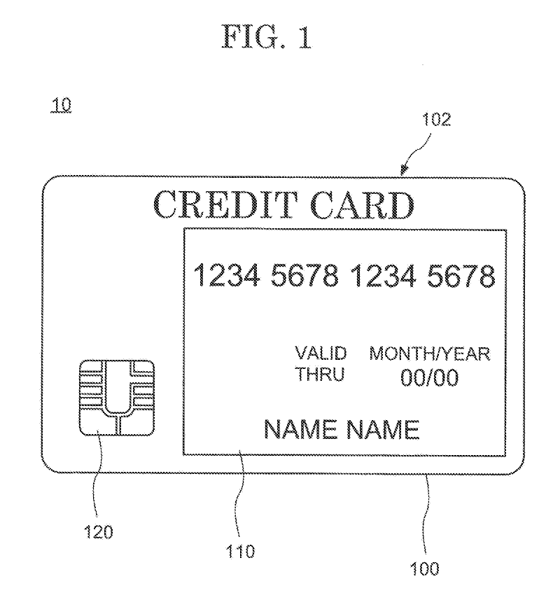

A card type device 10 related to one embodiment of the present invention is explained using FIG. 1 to FIG. 3B. FIG. 1 is a planar view diagram showing an external appearance of the card type device 10 related to one embodiment of the present invention. The card type device 10 related to the first embodiment includes a card 100, display 110 and an IC chip 120. The card 100 has flexibility. The display 110 is arranged on the card 100. That is, the display 110 is arranged in a region on the inner side of the card 100 in a planar view. The display 110 includes flexibility the same as the card 100. A printed region 102 showing [CREDIT CARD] is arranged on the surface of the card 100.

A plate made from a resin may be used as the card 100. The card type device of the present embodiment includes a structure in which two resin plates are bonded together. Although the thickness of the card 100 can be arbitrarily set, it is possible to set the thickness to 0.76 mm or less for example. Furthermore, the thickness of the display 110 is preferred to be set to a thickness of the card 100 or less. The size of the card 100 in a planar view can be set to 86 mm×54 mm for example. However, the structure of the card 100 is not limited to a structure in which two resin plates are bonded together. For example, a structure is possible in which the display 110 and IC chip 120 are arranged above one resin plate and covering these with a resin thin film. Components which form the card 100 are not limited to resin plates and may also be films made of a resin.

An engraved region may also be arranged in place of the printed region 102 on the surface of the card 100. All basic data of the card 100 is displayed in the display 110 so that it is not necessary to arrange a printed region on the surface of the card 100.

A display device such as a liquid crystal display device (LCD), organic light emitting device (OLED) or electronic paper and the like may be used as the display 110. For example, in the case where a LCD is used as the display 110, a LCD using an organic EL used as a backlight, a reflective type LCD which does not have a backlight or a transparent display LCD having a transparent background may be used as the display 110. In the case where an organic EL device is used for the display 110, a top-emission type, bottom-emission type or dual-emission type organic EL device may be used as the display 110.

For example, information such as card number, card expiration date, holder's name, holder's photograph and holder's signature and the like is displayed in the display 110. The information displayed in the display 110 may also be rewritten. A service URL linked with the card type device, a login ID to the service or login password may also be displayed in the display 110 by an instruction of a user. A one-time password (OTP) with a limited expiration date may also be displayed as the login password described above.

A contact type IC chip in which a connection terminal is exposed on the surface, or a contactless type IC chip (RFID for example) in which an antenna is arranged for wireless communication with external devices may be used as the IC chip 120. The IC chip 120 shown in FIG. 1 is a contact type IC chip formed with a connection terminal pattern on the surface. The IC chip 120 is arranged with a memory circuit or calculation processing circuit. A rewritable memory or non-rewritable memory may be used as the memory circuit. For example, information such as card expiration date, holder's name and holder's photograph and the like which is information that is likely to be renewed is stored in a rewritable memory, and information such as a card number or fixed information of the IC chip 120 which will not be renewed is stored in a non-rewritable memory.

### [Structure of Card Type Device 10]

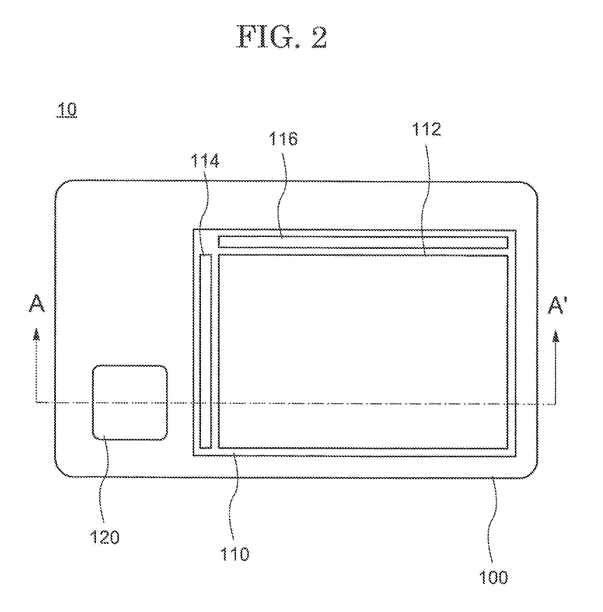

FIG. 2 is a planar view diagram showing a structure of a card type device related to one embodiment of the present invention. As is shown in FIG. 2, the display 110 and IC chip 120 are arranged on the card 100. The display 110 includes a display region 112, a card driver circuit 114, and a data driver circuit 116. Although described in detail herein, pixels for displaying an image are arranged in a matrix shape in the display region 112. Each pixel arranged in the display region 112 is connected to a gate line extending from the gate driver circuit 114 and a data line extending from the data driver circuit 116.

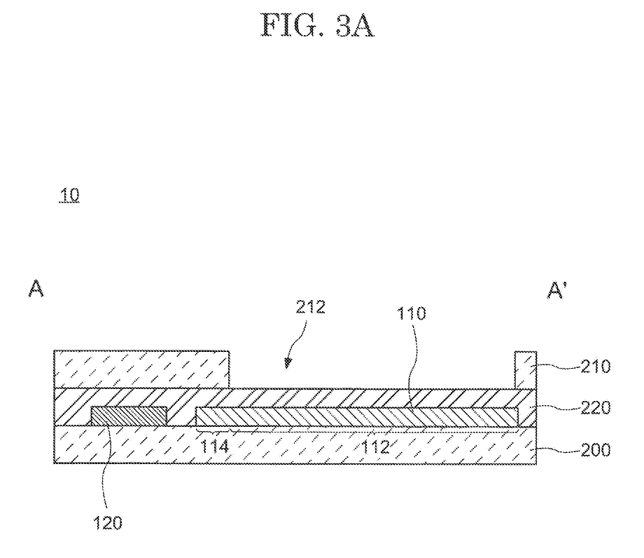

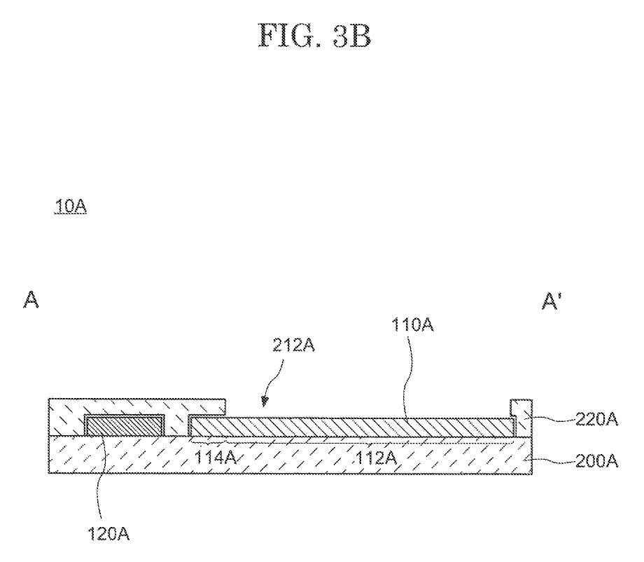

FIG. 3A is a cross-sectional diagram along the line A-A′ of the card type device related to one embodiment of the present invention. As is shown in FIG. 3A, the card type device 10 includes a first base 200, a second base 210, a resin layer 220, a display 110 and an IC chip 120. The display 110 and IC chip 120 are arranged above the first base 200. The resin layer 220 is arranged so as to cover the display 110 and IC chip 120. The second base 210 is arranged above the resin layer 220. An opening part 212 is arranged in a region corresponding to the display 110 in the second base 210. The resin layer 220 fixes the first base 200 with the second base 210. The resin layer 220 planarizes a step formed between the display 110 and first base 200, and a step formed between the IC chip 120 and first base 200. When the relationship between the display 110 and the opening part 212 is explained in detail, the opening part 212 opens a region corresponding to the display region 112, and the gate driver circuit 114 and the data driver circuit 116 overlap with the second base 210 in a planar view.

It is not necessary that the opening part 212 and the display region 112 completely match and the opening part 212 may be wider than the display region 112 or reversely, the opening part 212 may be narrower than the display region 112. That is, a part of the second base 210 may overlap the display 110 in a planar view. Although a structure is exemplified in FIG. 3A in which the opening part 212 is arranged in the second base 210 corresponding to the area where the display 110 is arranged, the present invention is not limited to this structure. For example, a structure is possible in which an opening part is not arranged in the second base 210 and a region of the second base 210 corresponding to the display 110 is transparent. Here, [transparent] means having translucency with respect to visible light to the extent that a user can visually recognize.

Although a structure is exemplified in FIG. 3A in which the resin layer 220 thicker than the display 110 and IC chip 120 is arranged in order to planarize a step formed by the display 110 and IC chip 120, the present invention is not limited to this structure. As in the modified example of the first embodiment shown in FIG. 3B for example, a second base 210A in which a concave part is arranged so as to enclose a display 110A and an IC chip 120A, may be adhered to a first base 200A. In the case of the structure shown in FIG. 3B, the resin layer 220 shown in FIG. 3A is omitted and the first base 200A and second base 210A are adhered together. Although a structure is exemplified in FIG. 3B in which a concave part is arranged in the second base 210A, the present invention is not limited to this structure. For example, a similar concave part may be arranged in the first base 200A or a concave part may be arranged in both the first base 200 and second base 210.

As described above, according to the card type device 10 related to the first embodiment, a card type device is provided which can change display data by using the display 110 in a region for displaying basic data of the card type device 10.

### Second Embodiment

### [Structure of Card Type Device 10B]

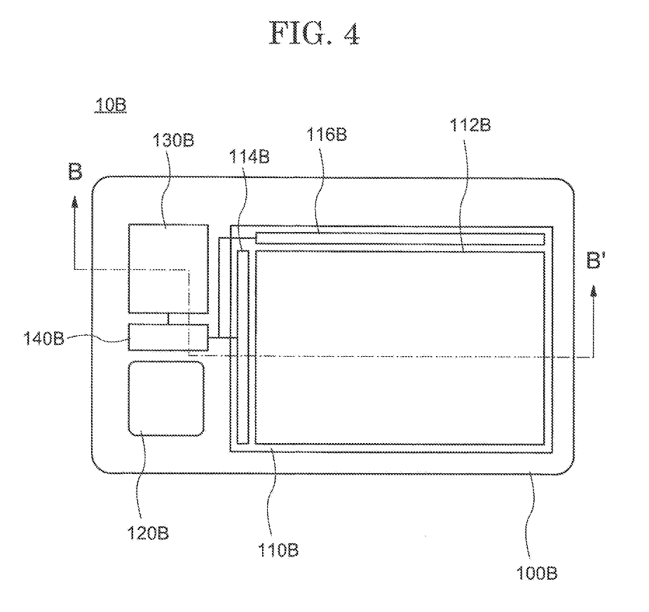

A summary of a card type device related to one embodiment of the present invention is explained using FIG. 4 to FIG. 10. In the second embodiment, a card type device 10B which performs authentication of a user when a user contacts the front and rear surfaces of a card type device is explained.

FIG. 4 is a planar view diagram showing a structure of a card type device related to one embodiment of the present invention. As is shown in FIG. 4, a display 110B, IC chip 120B, first touch sensor 130B and control circuit 140B are arranged on a card 100B. Although not shown in FIG. 4, as is described herein a second touch sensor 150B is arranged on an opposite side (rear surface side) to the side on which the first touch sensor 130B is arranged. The display 110B includes a display region 112B, gate driver circuit 114B and a data driver circuit 116B. The control circuit 140B is connected to the first touch sensor 130B, second touch sensor 150B, gate driver circuit 114B and data driver circuit 116B.

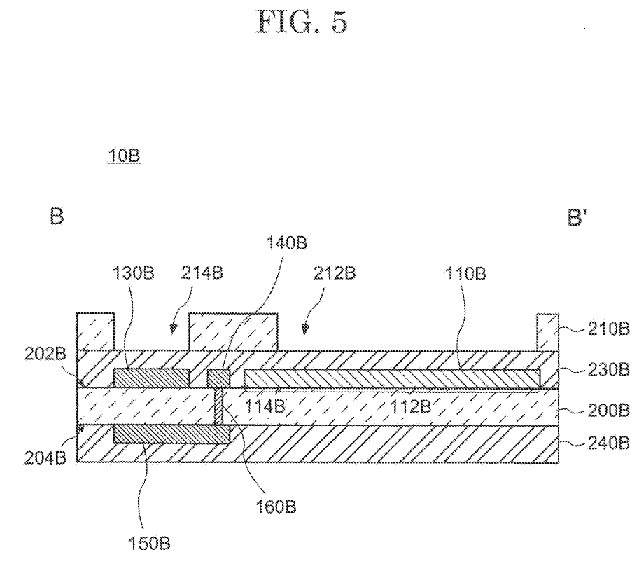

FIG. 5 is a cross-sectional diagram of the line B-B′ of the card type device related to one embodiment of the present invention. As is shown in FIG. 5, the card type device 10B includes a first base 200B, second base 210B, first resin layer 230B, second resin layer 240B, display 110B, first touch sensor 130B, second touch sensor 150B, control circuit 140B and through electrode 160B.

The display 110B, first touch sensor 130B and control circuit 140B are arranged on a first surface 202B side (front surface side) of the first base 200B. The second touch sensor 150B is arranged on a second surface 204B side (rear surface side) of the first base 200B. The through electrode 160B passes through the first surface 202B and second surface 204B of the first base 200B and connects the second touch sensor 150B with the control circuit 140B.

The first resin layer 230B is arranged so as to cover the display 110B, first touch sensor 130B and control circuit 140B. The second base 210B is arranged above the first resin layer 230B. Opening parts 212B and 214B are arranged in a region corresponding to the display 110B and first touch sensor 130B in the second base 210B. The first resin layer 230B fixes the first base 200B with the second base 210B. The first resin layer 230B planarizes a step between the display 110B and the first base 200B, a step between the first touch sensor 130B and first base 200B and a step between the control circuit 140B and first base 200B. When the relationship between the display 110B and opening part 212B is explained in detail, the opening part 212B opens a region corresponding to the display region 112B, and the gate driver circuit 114B and the data driver circuit 116B overlap with the second base 210B in a planar view.

Here, it is not necessary that the opening part 212B and the display region 112B completely match and the opening part 212B may be wider than the display region 112B or reversely, the opening part 212B may be narrower than the display region 112B. That is, a part of the second base 210B may overlap the display 110B in a planar view. Similarly, it is not necessary that the opening part 214B and a region where the first touch sensor 130B is arranged completely match and the opening part 214B may be wider than a region where the first touch sensor 130B is arranged or reversely, the opening part 214B may be narrower than a region where the first touch sensor 130B is arranged.

Although a structure is shown in FIG. 5 in which the opening part 212B is arranged in a region of the second base 210B corresponding to the display 110B, the present invention is not limited to this structure. For example, a structure is possible in which an opening part is not arranged in the second base 210B and a region of the second base 210B corresponding to the display 110B is transparent. Although a structure is shown in FIG. 5 in which the opening part 214B is arranged in the second base 210B corresponding to the area where the first touch sensor 130B is arranged, the present invention is not limited to this structure. It is not necessary to arrange the opening part 214B as long as the first touch sensor 130B can detect contact with the card type device 10B by a user.

The second resin layer 240B is arranged so as to cover the second touch sensor 150B. Although a structure is exemplified in FIG. 5 in which the second resin layer 240B is exposed to the surface, a base may be arranged further below the second resin layer 240B.

A resistance film type, an electrostatic capacitance type or optical type touch sensor is used as the first touch sensor 130B and second touch sensor 150B. The first touch sensor 130B and second touch sensor 150B may also include a fingerprint detection function and a location detection function.

### [Functional Structure of Card Type Device 10B]

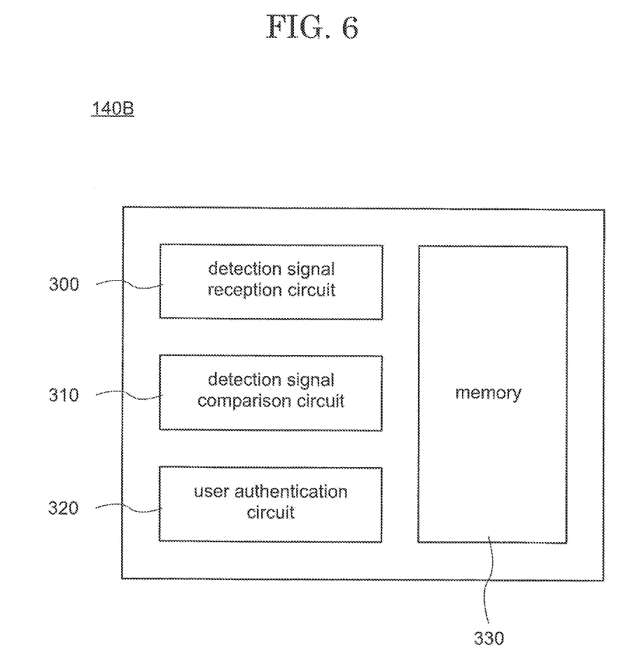

FIG. 6 is a block diagram showing a functional structure of a control circuit of the card type device related to one embodiment of the present invention. As is shown in FIG. 6, the control circuit 140B of the card type device 10B includes a detection signal reception circuit 300, a detection signal comparison circuit 310, a user authentication circuit 320 and a memory 330.

The detection signal reception circuit 300 receives a detection signal showing contact of a user with the first touch sensor 130B and second touch senor 150B from these touch sensors. The detection signal reception circuit 300 can receive a detection signal merely showing the presence of contact, a detection signal including fingerprint pattern data obtained from the finger of user who contacted the touch sensor or a detection signal including location data where the user contacted the touch sensor. When the detection signal reception circuit 300 receives this data, the data is correlated with the touch sensor which was detected as being contacted and the data is stored in the memory 330.

The detection signal comparison circuit 310 reads a first detection signal correlated with the first touch sensor 130B stored in the memory 330, and a second detection signal correlated with the second touch sensor 150B, and compares these detection signals. The detection signal comparison circuit 310 may compare the detected first detection signal with the second detection signal, and may also compare the detected first detection signal or second detection signal with reference data stored in the memory 330 in advance.

The user authentication circuit 320 determines whether a user who has contacted the first touch sensor 130B and second touch sensor 150B is an appropriate user based on a comparison result carried out by the detection signal comparison circuit 310. A determination of the user authentication circuit 320 may be carried out based on a timing when the first detection signal and second detection signal described above are detected, or may be carried out using pattern recognition based on data included in the first detection signal and second detection signal. For example, it is possible to use a MT system (Mahalanobis Taguchi System) which evaluates the relevance with respect to two patterns based on the distance from a unit space as the pattern recognition technology. When the user authentication circuit 320 determines that a user who has contacted a touch senor is an appropriate user, the user is permitted to perform subsequent operations. The pattern recognition method described above is called pattern matching.

A non-volatile memory such as EEPROM (Electrically Erasable Programmable Read-Only Memory), Flash Memory, Magnetoresistive Random Access Memory (MRAM), Phase-Change Memory (PRAM), Resistive Random Access Memory (ReRAM) or Ferroelectric Random Access Memory (FeRAM) may be used as the memory 330.

### [Operation Flow of Card Type Device 10B]

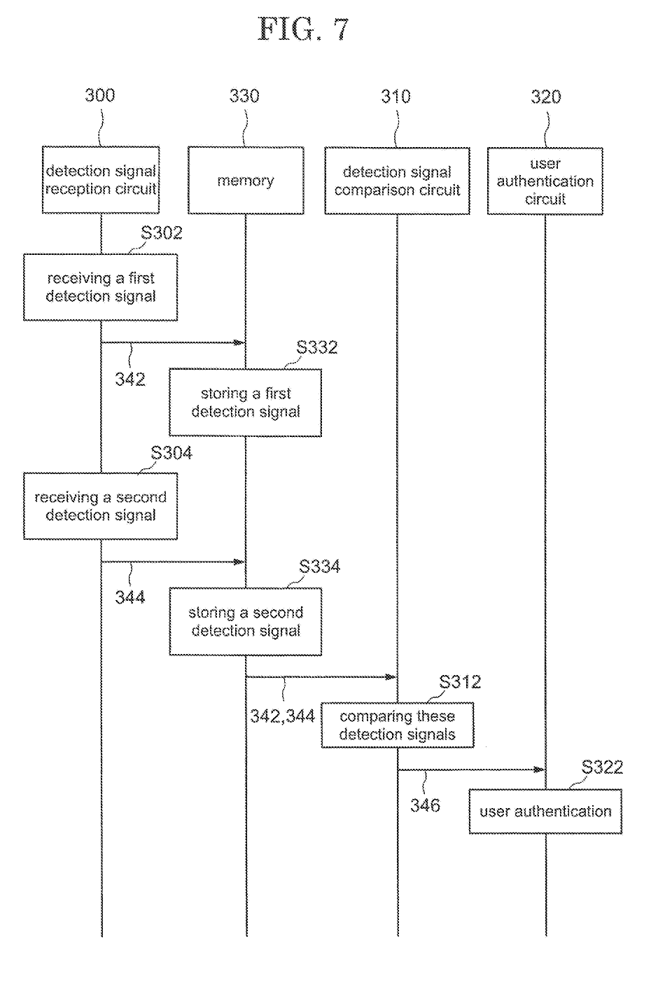

FIG. 7 is a flowchart showing the operation of a card type device related to one embodiment of the present invention. In FIG. 7, the operation of each block of the card type device 10B shown in FIG. 6 is explained in detail using a flowchart.

First, a first detection signal 342 showing that a user has contacted the first touch sensor 130B is received by the detection signal reception circuit 300 (step S302). The received first detection signal 342 is sent from the detection signal reception circuit 300 to the memory 330, correlated with the first touch sensor 130B and stored in the memory 330 (step S332). Next, a second detection signal 344 showing that a user has contacted the second touch sensor 150B is received by the detection signal reception circuit 300 (step S304). The received second detection signal 344 is sent from the detection signal reception circuit 300 to the memory 330, correlated with the second touch sensor 150B and stored in the memory 330 (step S334).

Next, the detection signal comparison circuit 310 reads the first detection signal 342 and second detection signal 344 stored in the memory 330 and compares these detection signals (step S312). The detection signal comparison circuit 310 may also read reference data for comparing with the first detection signal 342 or the second detection signal 344. A comparison result 346 compared by the detection signal comparison circuit 310 is sent to the user authentication circuit 320, and user authentication is performed based on the comparison result 346 (step S322).

Although an operation flow for reading both the first detection signal 342 and second detection signal 344 by the detection signal comparison circuit 310 after these detection signals have been stored in the memory 330 is exemplified in FIG. 7, the present invention is not limited to this operation flow. For example, the detection signal comparison circuit 310 may read the first detection signal 342 before the second detection signal 344 is received by the detection signal reception circuit 300.

### [Driving Method of Card Type Device 10B]

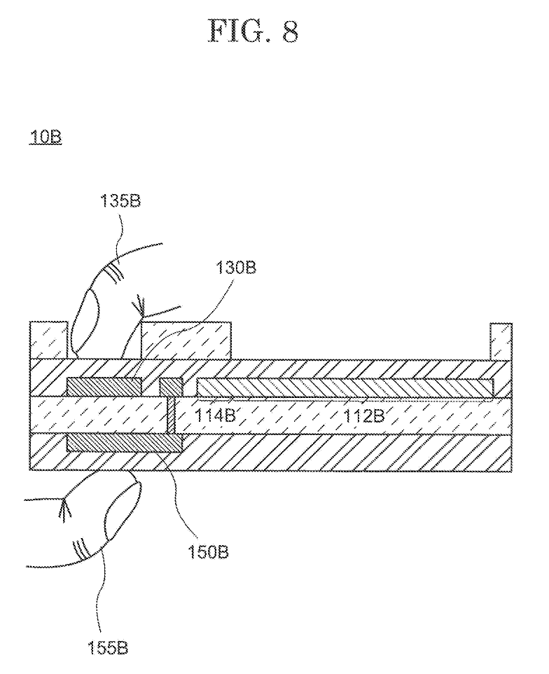

A driving method of the card type device 10B is explained using FIG. 8 to FIG. 10. Here, a method whereby the card type device 10B authenticates a user when a user touches the first touch sensor 130B on the front surface and the second touch sensor 150B on the rear surface of the card type device 10B is explained.

FIG. 8 is a diagram for explaining the operation of a card type device related to one embodiment of the present invention. As is shown in FIG. 8, the first touch sensor 130B and second touch sensor 150B each detect a first finger 135B and second finger 155B of a user respectively. As described herein, detection of the first finger 135B and second finger 155B may be simultaneous or at a different timing. The first touch sensor 130B and second touch sensor 150B may each include a pattern recognition function. That is, the first touch sensor 130B and second touch sensor 150B may obtain fingerprint data of the first finger 135B and second finger 155B.

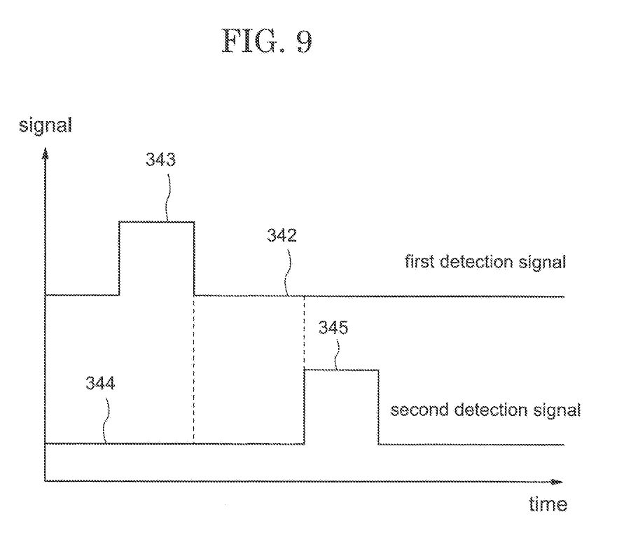

FIG. 9 is diagram for explaining a user authentication method of a card type device related to one embodiment of the present invention. The timing chart shown in FIG. 9 shows a case where detection of the first finger 135B and second finger 155B described above is carried out at a different timing. A first peak 343 of the first detection signal 342 is a signal showing that the first finger 135B has been detected by the first touch sensor 130B. A second peak 345 of the second detection signal 344 is a signal showing that the second finger 155B has been detected by the second touch sensor 150B. In this way, more stable user authentication is carried out if authentication is carried after one finger has been detected and by waiting for detection of the other finger.

As is shown in FIG. 9, the first peak 343 and second peak 345 occur at a different timing. In this case, user authentication may be carried out when the second peak 345 occurs within a certain time period after the time when the first peak 343 occurs. Alternatively, the first touch sensor 130B may obtain a fingerprint pattern of the first finger 135B using the first peak 343 as a trigger, the second touch sensor 150B may obtain a fingerprint pattern of the second finger 155B using the second peak 345 as a trigger, and user authentication may be carried out based on these fingerprint patterns. In other words, user authentication may be carried out by pattern matching of these fingerprint patterns.

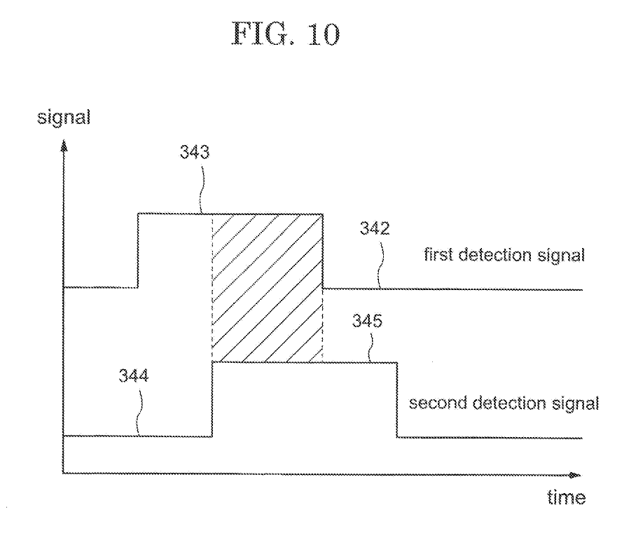

FIG. 10 is a diagram for explaining a user authentication method of a card type device related to one embodiment of the present invention. The timing chart shown in FIG. 10 shows the case where detection of the first finger 135B and second finger 155B described above is carried out at the same timing. As is shown in FIG. 10, user authentication may be carried out at the same time when both the first peak 343 and second peak 345 occur (time band of the diagonal line region in FIG. 10). Although user authentication may be carried out when the first peak 343 and second peak 345 occur simultaneously, user authentication may be still carried out by pattern matching of a user's fingerprint pattern as described above.

As described above, according to the card type device 10B related to the second embodiment, user authentication with higher security is provided by a simple method by authenticating a user when a front and rear surface of the card type device 10B are touched.

### Third Embodiment

### [Structure of Card Type Device 10C]

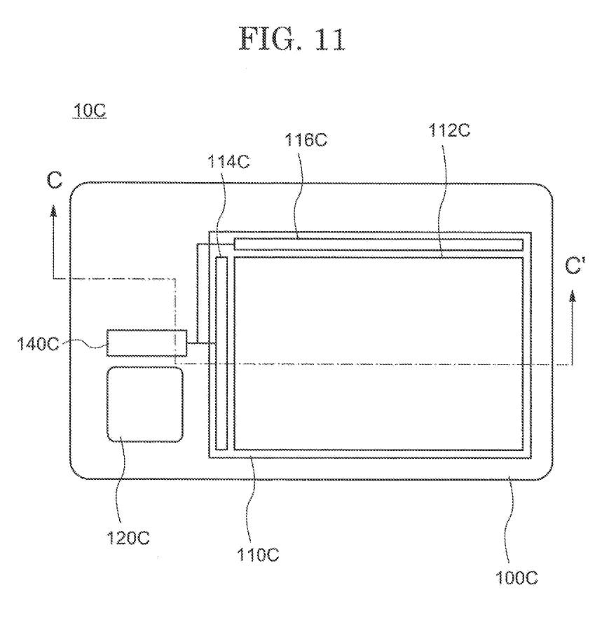

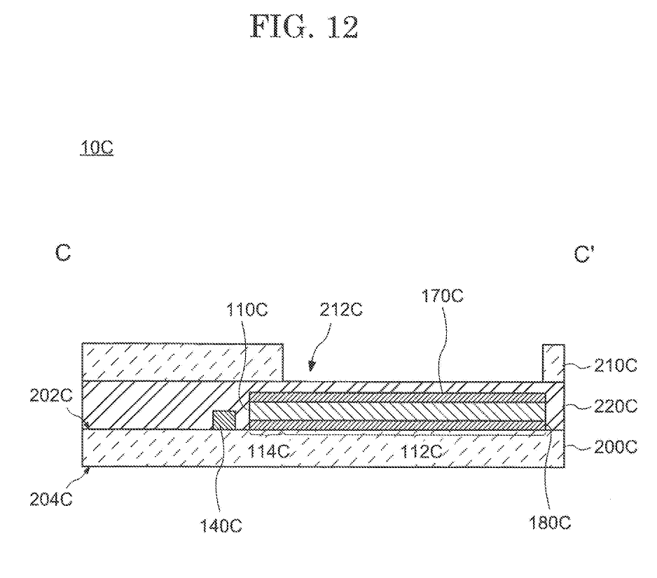

A summary of a card type device related to one embodiment of the present invention is explained using FIG. 11 and FIG. 12. The same as the second embodiment, in the third embodiment a card type device 100 which carries out user authentication by a user contacting a front and rear surface of a display of the card type device is explained.

FIG. 11 is a planar view diagram showing a structure of a card type device related to one embodiment of the present invention. As is shown in FIG. 11, a display 110C, IC chip 120C and control circuit 140C are arranged on a card 100C. The display 110C includes a display region 112C, a gate driver circuit 114C and a data driver circuit 116C. Although shown in detail in FIG. 12, a first touch sensor 170C and second touch sensor 180C are arranged above and below the display 110C. The control circuit 140C is connected to the first touch sensor 170C, second touch sensor 180C, gate driver circuit 114C and data driver circuit 116C.

FIG. 12 is a cross-sectional diagram of the line C-C′ of a card type device related to one embodiment of the present invention. As is shown in FIG. 12, the card type device 100 includes a first base 200C, second base 210C, resin layer 220C, display 110C, first touch sensor 170C, second touch sensor 180C and a control circuit 140C. The first touch sensor 170C is arranged on a first surface side 202C (front surface side) of the first base 200C. In other words, the first touch sensor 170C is arranged between the first base 200C and the display 110C. The second touch sensor 180C is arranged on a second surface side 204C (rear surface side) of the second touch sensor 180C. In other words, the first base 200C is arranged between the second base 210C and the display 110C.

The resin layer 220C is arranged to cover the display 110C, first touch sensor 170C, second touch sensor 180C and control circuit 140C. The second base 210C is arranged above the resin layer 220C. An opening part 212C is arranged in a region corresponding to the display 110C in the second base 210C. The resin layer 220C fixes the first base 200C with the second base 210C. The resin layer 220C planarizes a step between the display 110C and the first base 200C, a step between the first touch sensor 170C and the first base 200C, a step between the second touch sensor 180C and the first base 200C, and a step between the control circuit 140C and the first base 200C. The relationship between the display 110C and the opening part 212C is the same as in the first embodiment and second embodiment.

A resistance film type, an electrostatic capacitance type or an optical type touch sensor is used as the first touch sensor 170C and second touch sensor 180C. The first touch sensor 170C and second touch sensor 180C may also include a fingerprint detection function and a location detection function. The first touch sensor 170C and second touch sensor 180C may also be in-cell type touch sensors in which a sensor element is arranged within a pixel of the display region 112C.

Since the functional structure, operation flow and driving method of the card type device 100 is the same as the card type device 10B shown in FIG. 6 to FIG. 10, an explanation is omitted here.

As described above, according to the card type device 100 related to the third embodiment, user authentication with higher security is provided by a simple method by authenticating a user when a front and rear surface of the display 110C of the card type device 100 are touched. Since it is not necessary to separately arrange a touch sensor region in regions other than the display 110C, a wider region of the display 110C may be arranged.

### Fourth Embodiment

### [Structure of Card Type Device 10D]

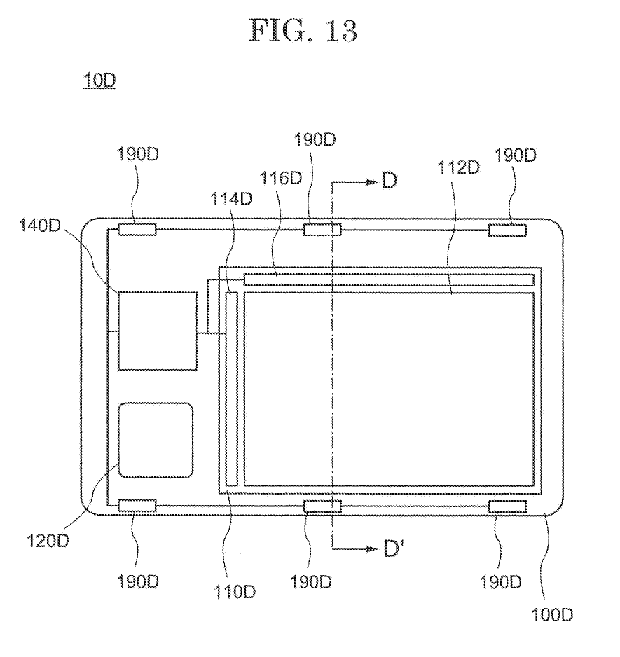

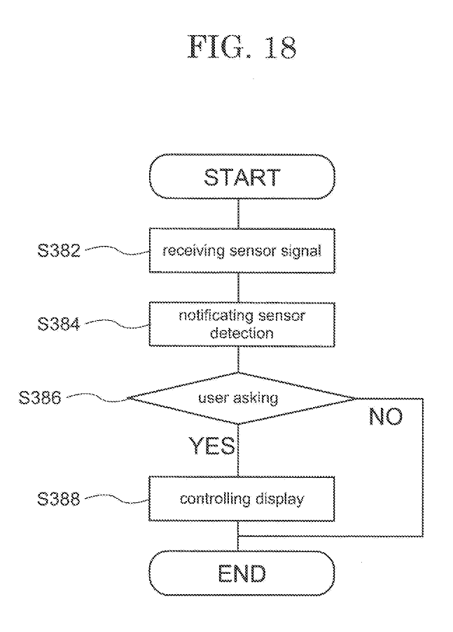

A summary of a card type device related to one embodiment of the present invention is explained using FIG. 13 and FIG. 18. In the fourth embodiment, a card type device 10D which can switch an image displayed in a display of the card type device to another image by a user bending the card type device is explained.

FIG. 13 is a planar view diagram showing a structure of a card type device related to one embodiment of the present invention. As is shown in FIG. 13, a display 110D, IC chip 120D, control circuit 140D and a plurality of detection sensors 190D are arranged on a card 100D. The display 110D includes a display region 112D, a gate driver circuit 114D and a data driver circuit 116D. The detection sensor 190D detects a change in the shape of the card type device 10D. The control circuit 140D is connected to the plurality of detection sensors 190D, the gate driver circuit 114D and data driver circuit 116D.

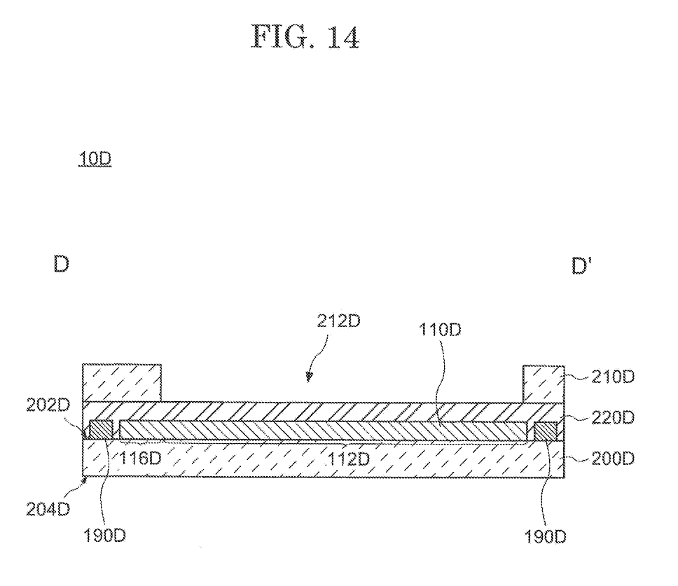

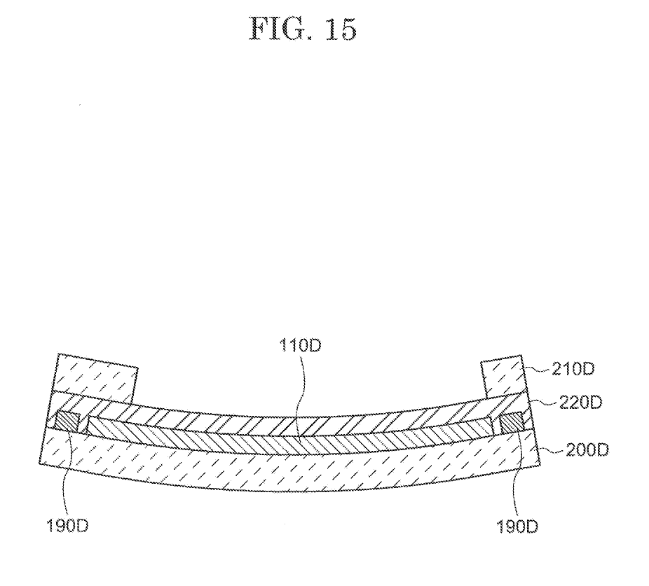

FIG. 14 is a cross-sectional diagram along the line D-D′ of a card type device related to one embodiment of the present invention. FIG. 15 is a diagram for explaining an operation of a card type device related to one embodiment of the present invention. The detection sensor 190D is arranged on a first surface side 202D (front surface side) of a first base 200D. An example of a bent card type device 10D is shown in FIG. 15 as an example of a change in shape of the card type device 10D. As is shown in FIG. 15 the first base 200D bends together with bending of the card type device 10D, and the bending of the first base 200D is detected by the detection sensor 190D arranged above the first base 200D. At this time, the detection sensor 190D generates a detection signal showing a change in shape of the first base 200D

As is shown in FIG. 14, a resin layer 220D is arranged so as to cover the display 110D and the detection sensor 190D. The second base 210D is arranged above the resin layer 220D. An opening part 212D is arranged in the second base 210D in a region corresponding to the display 110D. The resin layer 220D fixes the first base 200D and second base 210D together. The resin layer 220D planarizes a step between the display 110D and the first base 200D, and a step between the detection sensor 190D and the first base 200D. Here, the relationship between the display 110D and the opening part 212D is the same as the other embodiments.

For example, a dynamic sensor such as acceleration sensor or an angular velocity sensor which use MEMS (Micro Electro Mechanical Systems) technology may be used as the detection sensor 190D. More specifically, a piezoresistance type sensor may be used as the detection sensor 190D. A piezoresistance type sensor is a sensor formed with a movable part above a semiconductor substrate and which changes in shape according to an external force, and is a type of sensor which detects a change in shape of this movable part using a piezo-electric element.

Apart from the dynamic sensors described above, an optical sensor may also be used as the detection sensor. For example, a semiconductor device whose characteristics change according to the amount of light received may be used as the optical sensor. More specifically, a diode in which an amount of generated current changes according to the amount of light received may be used. Alternatively, a transistor in which an ON/OFF threshold value changes according to the amount of light received may also be used.

### [Functional Structure of Card Type Device 10D]

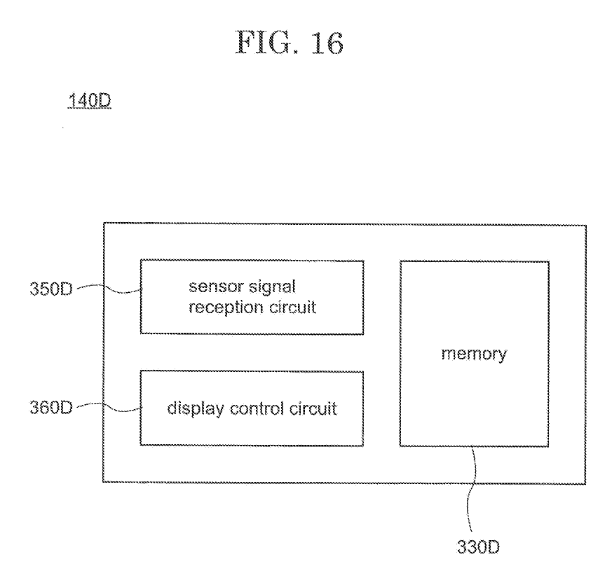

FIG. 16 is a block diagram showing a functional structure of a control circuit of card type device related to one embodiment of the present invention. As is shown in FIG. 16, the control circuit 140D of the card type device 10D includes a sensor signal reception circuit 350D, a display control circuit 360D and a memory 330D.

The sensor signal reception circuit 350D receives a detection signal showing a change in shape of the first base 200D generated by the detection sensor 190D. The sensor signal reception circuit 350D can detect a change in shape of the first base 200D based on a signal received from one detection sensor 190D arranged in the card type device 10D or a signal received from a plurality of detection sensors 190D.

For example, in the case where a piezo-electric element is used as the detection sensor 190D, a change in shape of the first base 200D can be detected just by the piezo-electric element. In this case, the senor signal reception circuit 350D receives a detection signal showing a change in shape of the first base 200D has occurred from at least one detection sensor 190D. In order to avoid a false detection by a detection sensor 190D, the fact that a change in shape of the first base 200D has occurred may be determined when a detection signal is received from a plurality of all of the detection sensors 190D. On the other hand, in the case where an optical sensor is used as the detection sensor 190D, the sensor signal reception circuit 350D can determine a change in shape of the first base 200D based on the amount of light detected by two or more optical sensors. For example, when the card type device 10D bends, the amount of change in the amount of light around the time when bending is detected by two optical sensors arranged in different positions is different. Therefore, a change in shape of the first base 200D may be detected based on a difference in the amount of change of the amount of light of two or more optical sensors.

The display control circuit 360D controls an operation of the display 110D based on a detection signal received or detected by the sensor signal reception circuit 350D. The detection signal shows a change in shape of the first base 200D has been determined. For example, the display control circuit 360D rewrites a screen image of the display 110D based on the detection signal described above. Specifically, the display control circuit 360D may switch the display 110D to OFF based on a detection signal. Alternatively, the display control circuit 360D may switch an image displayed in the display 110D to another image by a received detection signal from the sensor signal reception circuit 350D.

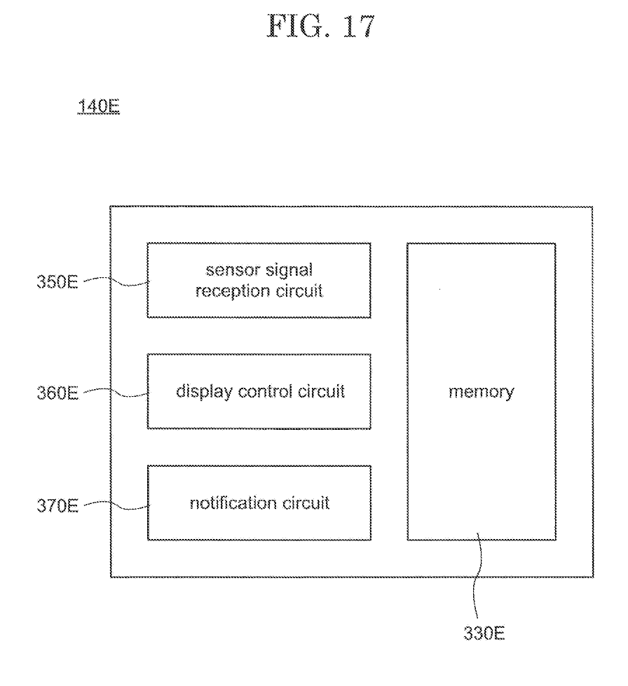

A modified example of the fourth embodiment is explained using FIG. 17 and FIG. 18. FIG. 17 is a block diagram showing a functional structure of a control circuit of a card type device related to a modified example of one embodiment of the present invention. Since the structure of a card type device 10E related to a modified example of the fourth embodiment is the same as the card type device 10D shown in FIG. 17, an explanation is omitted and FIG. 13 is referred to. As is shown in FIG. 13, a control circuit 140E of the card type device 10E related to a modified example of the fourth embodiment includes a notification circuit 370E in addition to a sensor signal reception circuit 350E, display control circuit 360E and memory 330E.

The notification circuit 370E notifies a user that a detection signal has been detected based on a detection signal received or detected by the sensor signal reception circuit 350E. The detection signal shows a determined change in shape of the first base 200D shown in FIG. 13 and FIG. 14. In addition, the notification circuit 370E asks a user whether execution of operation control of the display 110D shown in FIG. 13 and FIG. 14 is necessary or not. When a user instructs execution of operation control of the display 110D, an operation of the display 110D is controlled by the display control circuit 360E.

### [Operation Flow of Card Type Device 10E]

FIG. 18 is a flowchart showing an operation of a card type device related to one embodiment of the present invention. In FIG. 18, an operation of each block of the card type device 10E shown in FIG. 17 is explained in detail using a flowchart.

First, the detection sensor 190D shown in FIG. 13 and FIG. 14 receives a detection signal showing a change in shape of the first base 200D by the sensor signal reception circuit 350E (step S382). The received detection signal is sent to the notification circuit 370E from the sensor signal reception circuit 350E. The notification circuit 370E notifies a user that a change in shape of the first base 200D has occurred (step S384). For example, this notification asks a user whether operation control of the display 110D is necessary or not by displaying a message on the display 110D such as [A bend in the smartcard has been detected. Do you wish to turn off the display?].

On the other hand, a user may be asked whether operation control of the display 110D is necessary or not without notifying the user that a change in shape of the first base 200D has occurred. For example, a user may be asked whether operation control of the display 110D is necessary or not by simply displaying a message such as [Do you wish to turn off the display?].

When a user instructs execution of operation control of the display 110D ([YES] in step S386) in response to the notification described above, an instruction signal of the user is sent to the display control circuit 360E and operation control of the display 110D is executed (step S388). On the other hand, operation is finished when a user denies operation control of the display 110D ([NO] in step S386).

As described above, according to the card type device 10D related to the fourth embodiment, data displayed on the card type device 10D changes according to a single action which is a change in shape of the card type device 10D. Therefore, a burden on a user is reduced since a card type device which can change display data by a simple operation is provided. The card type device 10E related to a modified example of the fourth embodiment can prevent unintended operation control of a display by a user by asking a user whether a change in shape of the card type device 10E is an intentional act of the user or not.

### Fifth Embodiment

### [Structure of Card Type Device 10F]

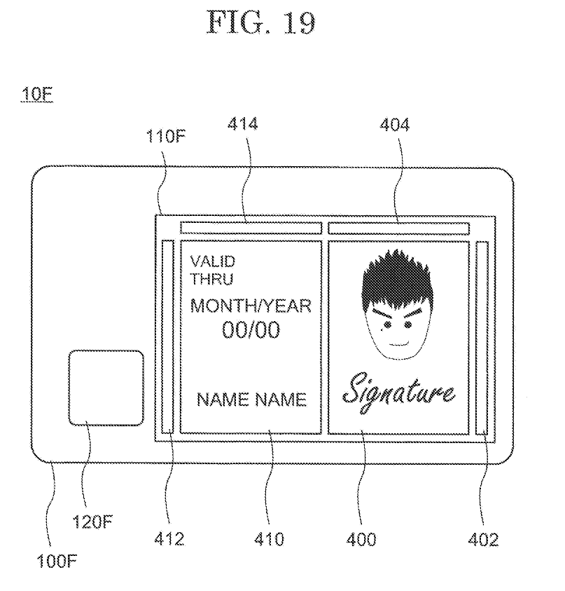

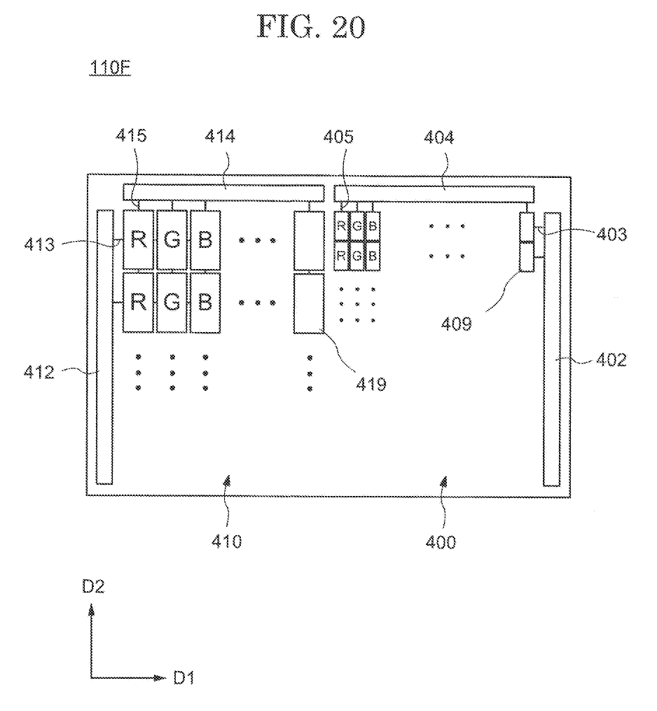

A summary of a card type device related to one embodiment of the present invention is explained using FIG. 19 and FIG. 20. In the fifth embodiment, a card type device 10F formed by a display region having different resolutions such as a high definition region and a low definition region for example, is explained.

FIG. 19 is a planar view diagram showing a structure of a card type device related to one embodiment of the present invention. As is shown in FIG. 19, a display 110F and IC chip 120F are arranged on a card 100F. The display 110F includes a first display region 400, a first gate driver circuit 402, a first data driver circuit 404, a second display region 410, a second gate driver circuit 412 and a second data driver circuit 414. Pixels for displaying an image are arranged in a matrix shape in the first display region 400 and second display region 410.

The resolution (number of data lines per unit length) of the second display region 410 is lower than the resolution of the first display region 400. That is, the first display region 400 is a high resolution display region and the second display region 410 is a low resolution display region. In other words, a pixel pitch interval of the second display region 410 is wide compared to a pixel pitch interval of the first display region 400. Each pixel arranged in the first display region 400 is connected to a gate line extending from the first gate driver circuit 402, and a data line extending from the first data driver circuit 404. Each pixel arranged in the second display region 410 is connected to a gate line extending from the second gate driver circuit 412, and a data line extending from the second data driver circuit 414.

For example, a complex image such as a photograph or signature of the holder of the card type device 10F may be displayed in the high resolution first display region. On the other hand, a relatively simple image such as a card number, card expiration date or holder's name displayed using a simple font may be display in the low resolution second display region.

FIG. 20 is a planar view diagram showing a pixel layout in a display region of a card type device related to one embodiment of the present invention. As is shown in FIG. 20, first pixels 409 are arranged in a matrix shape in the first display region 400 in the display 110F of the card type device 10F. Each of the first pixels 409 correspond to a RGB sub-pixel. A first pixel 409 is connected to a first gate line 403 extending from the first gate driver circuit 402, and a first data line 405 extending from the first data driver circuit 404. Second pixels 419 are arranged in a matrix shape in the second display region 410. A second pixel 419 is connected to a second gate line 413 extending from the second gate driver circuit 412, and a second data line 415 extending from the second data driver circuit 414.

In the case where the direction in which the first display region 400 and second display region 410 are aligned is set as a first direction D1, the first data driver circuit 404 and the second data driver circuit 414 are aligned so as to have a longer side in the first direction D1. On the other hand, the first gate driver circuit 402 and second gate driver circuit 412 have a longer side in a second direction D2 which intersects the first direction D1. The first display region 400 and the second display region 410 are arranged between these two driver circuits.

As is shown in FIG. 20, the size of a second pixel 419 is larger than the size of a first pixel 409, and a distance between the centers of adjacent pixels is wide. An interval between a pair of adjacent second gate lines 413 is wider than an interval between a pair of adjacent first gate lines 403. Similarly, an interval between a pair of adjacent second data lines 415 is wider than an interval between a pair of adjacent first data lines 405. With the structure described above, a high resolution first display region 400 and low resolution second display region 410 are realized.

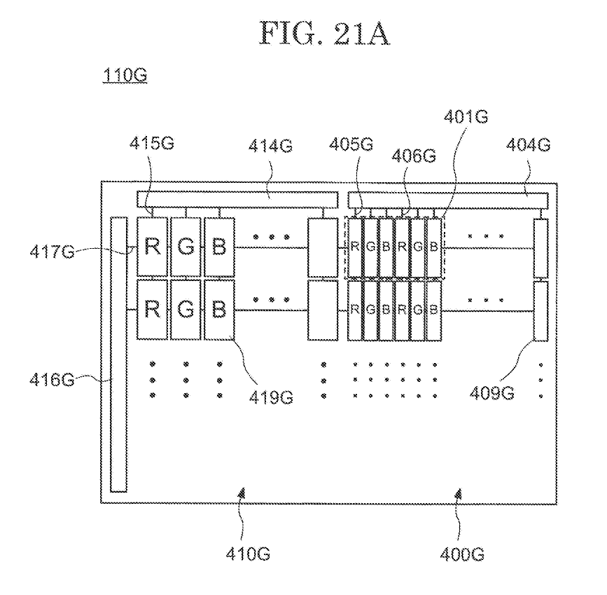

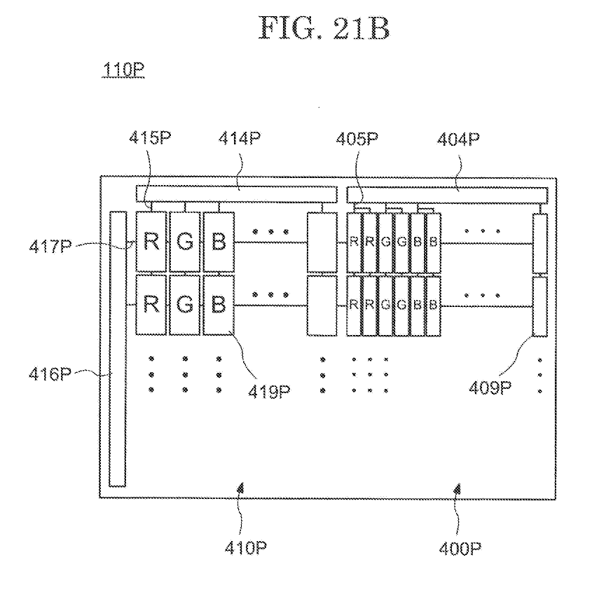

A modified example of the fifth embodiment is explained using FIG. 21A. FIG. 21A is a planar view diagram showing a pixel layout in a display region of a card type device related to a modified example of one embodiment of the present invention. Since the structure of a card type device 10G related to a modified example of the fifth embodiment is the same as the structure of the card type device 10F shown in FIG. 20, an explanation of the structure of the card type device 10G is omitted and a display 110G of the card type device 10G is explained while referring to FIG. 20.

As is shown in FIG. 21A, the size of a second pixel 419G in a direction in which a gate line 417G extends is larger than the size of a first pixel 409G and a pitch interval of the second pixel 419G is wider than the first pixel 409G. In other words, the size of a second pixel 419G is larger than a first pixel 409G in a direction in which a RGB sub-pixel is arranged and a pitch interval of the second pixel 419G is wider than the first pixel 409G. On the other hand, unlike FIG. 20, the size and pitch interval of the first pixel 409G and second pixel 419G in a direction in which a first data line 405G (or second data line 415G) extends are the same. Therefore, in FIG. 21A, the first pixel 409G in the first display region 400G and the second pixel 419G in the second display region 410G are connected to the same gate line 417G. That is, the first display region 400G and second display region 410G of the display 110G share the gate line 417G and both are connected by a gate driver circuit 416G.

Although a layout in which the first display region 400G and second display region 410G share a gate line 417G and gate driver circuit 416G is exemplified in FIG. 21A, the present invention is not limited to this layout. For example, each of the first display region 400G and second display region 410G may be arranged with a separate gate line and gate driver circuit.

For example, if different image data is supplied to adjacent pixels of the same color, it is possible to drive a display so that the three RGB sub-pixels of the first display region 400G become one main pixel. In this display method, the size of a main pixel of the first display region 400G is smaller than the size of a main pixel comprised from three RGB sub-pixels arranged in a horizontal direction of the second display region 410G. The display mode of the first display region 400G in this display method is called a high resolution mode. In a high resolution mode, it is possible to supply different image data to first data lines 405G and 406G respectively.

On the other hand, in FIG. 21A, if the same image data is supplied to adjacent pixels of the same color, a display can be driven so that six RGBRGB sub-pixels (pixel group 401G enclosed by a dotted line) arranged in a horizontal direction of the first display region 400G become one main pixel. In this display method, the size of a main pixel of the first display region 400G is the same size as a main pixel comprised from three RGB sub-pixels of the second display region 410G. The display mode of the first display region 400G in this display method is called a low resolution mode. In a low resolution mode, it is possible to supply the same image data to first data lines 405G and 406G respectively.

As described above, by controlling image data supplied to adjacent pixel columns of the same color, it is possible to switch a display mode of the first display region 400G to a high resolution mode or low resolution mode. This display mode switching can be realized by controlling the first data driver circuit 404G by a control circuit and the like.

As is shown in FIG. 21B, the resolution of the first display region 400P and second display region 410P may be changed by arranging a pixel having the same size as in FIG. 21A in a first display region 400P and second display region 410P respectively, individually controlling each sub-pixel in the second display region 410P and controlling a plurality of sub-pixels in the first display region 400P. As a specific example, the first data line 405P is split and connected to adjacent pixel columns of the same color as is shown in FIG. 21B. By driving adjacent pixel columns in a batch in this way, it is possible to set a display region to a low resolution mode.

As described above, according to the card type device 10F related to the fifth embodiment, power consumption of the display 110F is decreased by displaying data which requires a high resolution such as characters or numbers in the low resolution second display region 410. The proportion of power consumed by a data driver circuit is high in the power consumption of a display. Therefore, power consumption of the display 110G decreases by making the size and pitch of at least the second pixel 419G of the second display region 410G larger than the size and pitch of the first pixel 409G of the first display region 400G in a direction in which the gate line 417G extends as is shown in FIG. 21A and FIG. 21B.

Power consumption is high in the case of displaying an image in the first display region 400G. In addition, if the first display region 400G is a display region of a facial photograph, it is often assumed that it will be not be required to be displayed all the time. Consequently, a card type device displays an image in the second display region 410G and may include a first mode for not displaying an image in the first display region 400G, and a second mode for displaying an image in both the first display region 400G and second display region 410G. Switching between two modes may be performed by an operation of a user.

### Sixth Embodiment

### [Structure of Card Type Device 10H]

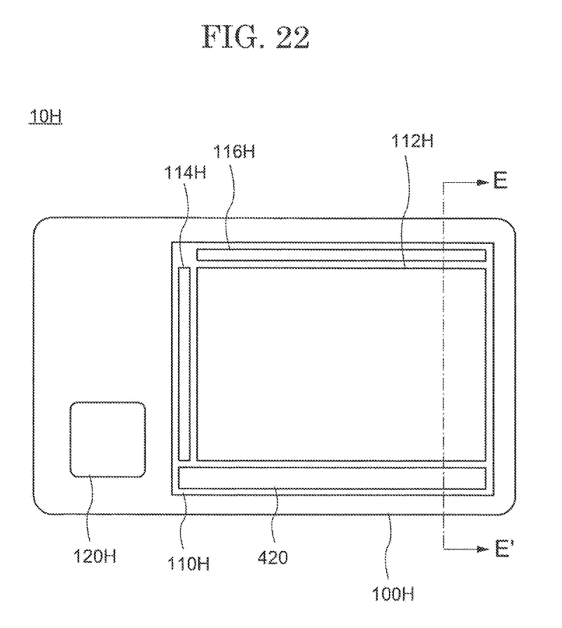

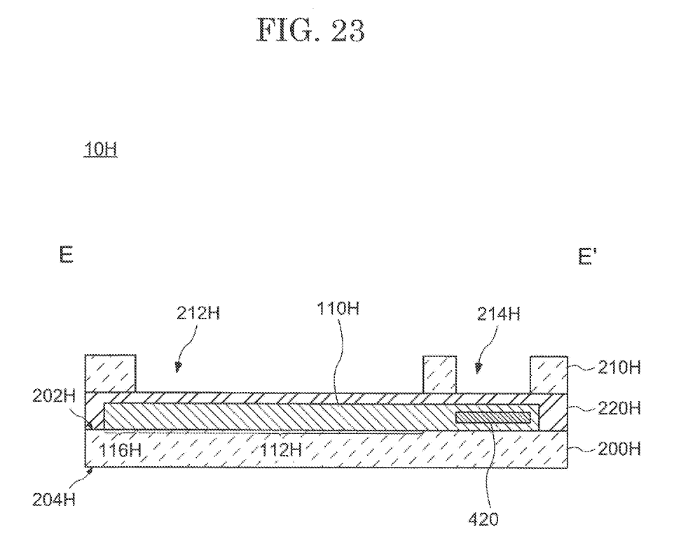

A summary of a card type device related to one embodiment of the present invention is explained using FIG. 22 and FIG. 23. In the sixth embodiment, a card type device 10H arranged with a magnetic sheet stored with unique data of the card is explained.

FIG. 22 is a planar view diagram showing a structure of a card type device related to one embodiment of the present invention. As is shown in FIG. 22, a display 110H and IC chip 120H are arranged on a card 100H. The display 110H includes a display region 112H, a gate driver circuit 114H, a data driver circuit 116H and a magnetic sheet 420. The magnetic sheet 420 is a storage element (storage part) stored with data using magnetism. Unique data such as a card number is stored in the magnetic sheet 420.

FIG. 23 is a cross-sectional diagram along the line E-E′ of a card type device related to one embodiment of the present invention. As is shown in FIG. 23, the feature of the present embodiment is that it includes the magnetic sheet 420. The display 110H and magnetic sheet 420 are arranged on a first surface side 202H (front surface side) of a first base 200H, and the magnetic sheet 420 is arranged within the display 110H. For example, the display 110H is formed including a plurality of insulation layers, and the magnetic sheet 420 is arranged between any two insulation layers among the plurality of insulation layers included in the display 110H. In other words, the magnetic sheet 420 is arranged between any two layers among the layers which form the display 110H.

As is shown in FIG. 23, a resin layer 220H is arranged so as to cover the display 110H and magnetic sheet 420. A second base 210H is arranged above the resin layer 220H. The second base 210H is arranged with an opening part 212H in a region corresponding to the display region 112H, and an opening part 214H in a region corresponding to the magnetic sheet 420. The resin layer 220H fixes the first base 200H and second base 210H together. The resin layer 220H planarizes a step between the display 110H and first base 200H, and a step between the magnetic sheet 420 and first base 200H. The relationship between the display 110H and the opening part 212H is the same as in the other embodiments.

It is not necessary that the opening part 214H and a region in which the magnetic sheet 420 is arranged completely match, and the opening part 214H may be wider than a region in which the magnetic sheet 420 is arranged, the opening part 214H may be narrower than a region in which the magnetic sheet 420 is arranged. Although a structure is exemplified in FIG. 23 in which the opening part 214H is arranged in a region of the second base 210H corresponding to the magnetic sheet 420, the present invention is not limited to this structure. The opening part 214H does not have to be arranged if a magnetic reading device can detect the magnetic sheet 420.

As described above, according to the card type device 10H related to the sixth embodiment, it is possible to protect the magnetic sheet 420 by arranging the magnetic sheet 420 stored with unique data of the card between any two layers which form the display 110H. With this structure, it is possible to prevent the magnetic sheet 420 from being damaged by external impacts. Since it is possible to suppress water, oxygen and ultraviolet rays and the like from reaching the magnetic sheet 420 with this structure, it is possible to suppress deterioration of the magnetic sheet 420.

### Seventh Embodiment

### [Structure of Card Type Device 10J]

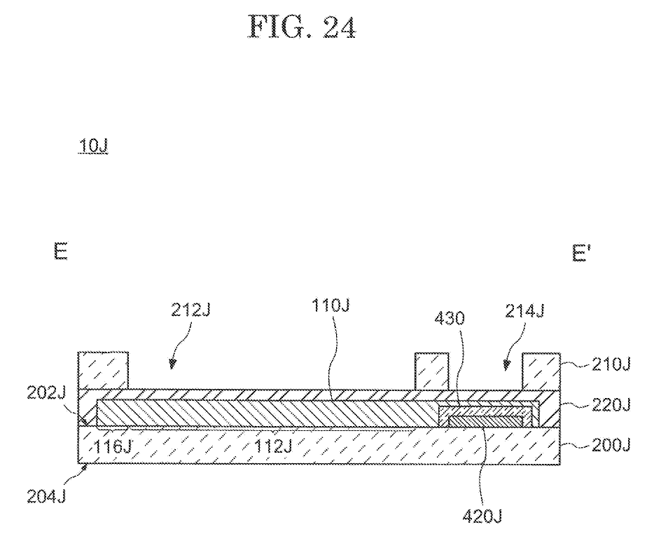

A summary of a card type device related to one embodiment of the present invention is explained using FIG. 24. In the seventh embodiment, a card type device 10J having a magnetic sheet covered by a protective member is explained. Since the structure of the card type device 10J is the same as the card type device 10H shown in FIG. 22, an explanation is omitted here and FIG. 22 is referred to.

FIG. 24 is a cross-sectional diagram along the line E-E′ of a card type device related to a modified example of one embodiment of the present invention. As is shown in FIG. 24, a display 110J, magnetic sheet 420J and protective member 430 are arranged on a first surface side 202J (front surface side) of a first base 200J, and the magnetic sheet 420J is covered by the protective member 430. Explained in more detail, the protective member 430 is arranged on an upper surface and side surface of the magnetic sheet 420J. That is, the protective member 430 covers a region which overlaps the magnetic sheet 420J when the protective member 430 is viewed from the direction of a second base 210J in a planar view in FIG. 24.

For example, a material having insulation properties and which is harder than a resin layer 220J, that is, a material with a high Young's modulus, is used as the protective member 430. Specifically, a UV curable resin may be used as the protective member 430. An acrylic based resin using a (meth) acrylate based monomer may be used as the UV curable resin.

Although a structure in which the magnetic sheet 420J and protective member 430 are arranged above the first base 200J is exemplified in FIG. 24, the present invention is not limited to this structure. For example, the magnetic sheet 420J and protective member 430 may be arranged between two layers among any of the layers which form the display 110J the same as in FIG. 23. The protective member 430 may be further arranged on a lower surface of the magnetic sheet 420J. That is, a structure is possible in which the magnetic sheet 420J is enclosed by the protective member 430.

As described above, according to the card type device 10J related to the seventh embodiment, it is possible to protect the magnetic sheet 420J when the magnetic sheet 420J stored with unique data of the card is covered by the protective member 430. With this structure, it is possible to prevent the magnetic sheet 420J from being damaged by external impacts. Since it is possible to suppress water, oxygen and ultraviolet rays and the like from reaching the magnetic sheet 420J with this structure, it is possible to suppress deterioration of the magnetic sheet 420J.

### Eighth Embodiment

### [Structure of Card Type Device 10K]

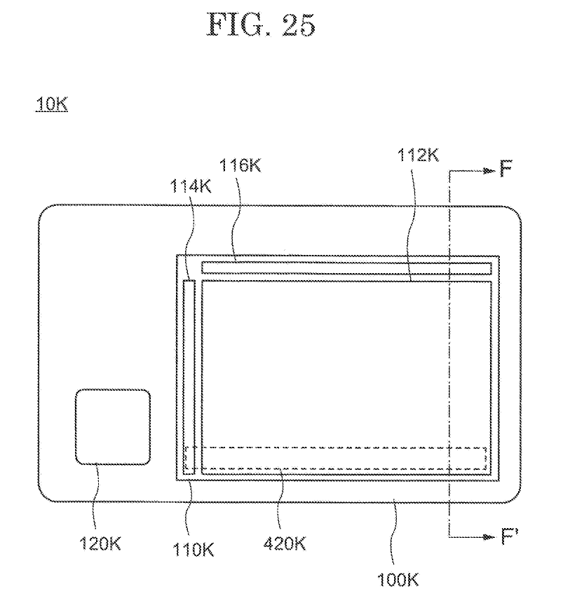

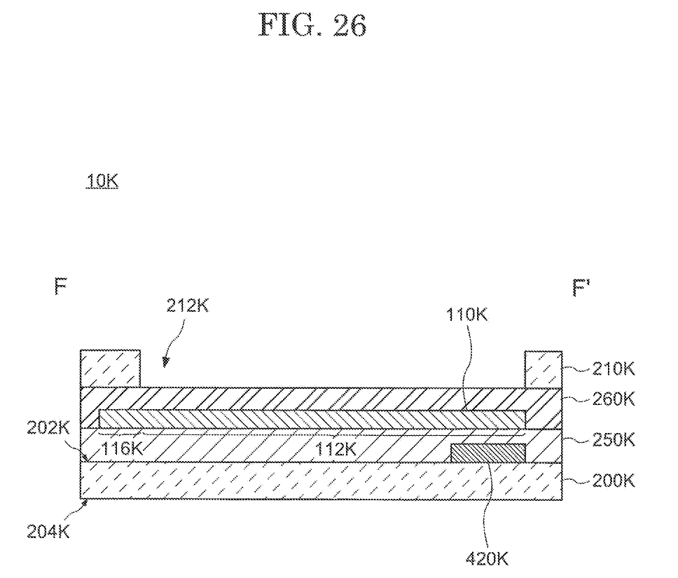

A summary of a card type device related to one embodiment of the present invention is explained using FIG. 25 and FIG. 26. In the eighth embodiment, a card type device 10K arranged with a magnetic sheet 420K in a region which overlaps a display region 112K of a display 110K in a planar view is explained.

FIG. 25 is a planar view diagram showing a structure of a card type device related to one embodiment of the present invention. As is shown in FIG. 25, a display 110K, IC chip 120K and magnetic sheet 420K are arranged on a card 100K. The display 110K includes a display region 112K, a gate driver circuit 114K and a data driver circuit 116K. The magnetic sheet 420K is arranged in a region which overlaps the display region 112K in a planar view. The display 110K is a reflective type liquid crystal display or a top-emission type organic EL display. That is, the magnetic sheet 420K cannot be viewed from a user in the card type device 10K.

FIG. 26 is a cross-sectional diagram along the line F-F′ of a card type device related to one embodiment of the present invention. As is shown in FIG. 26, the magnetic sheet 420K is arranged on a first surface side 202K (front surface side) of a first base 200K. A first resin layer 250K is arranged so as to cover the magnetic sheet 420K. The display 110K is arranged above the first resin layer 250K. A second resin layer 260K is arranged so as to cover the display 110K.

The first resin layer 250K and second resin layer 260K fix the first base 200K and a second base 210K together, and relax a step formed by the magnetic sheet 420K and display 110K. The relationship between the display 110K and an opening part 212K is the same as the details described in the other embodiments.

As described above, according to the card type device 10K related to the eighth embodiment, it is possible to arrange a wide display region by arranging the magnetic sheet 420K in a region which overlaps the display 110K in a planar view. Since the magnetic sheet 420K cannot be viewed by a user, a card type device with a smarter external appearance can be obtained.

### Ninth Embodiment

### [Structure of Card Type Device 10L]

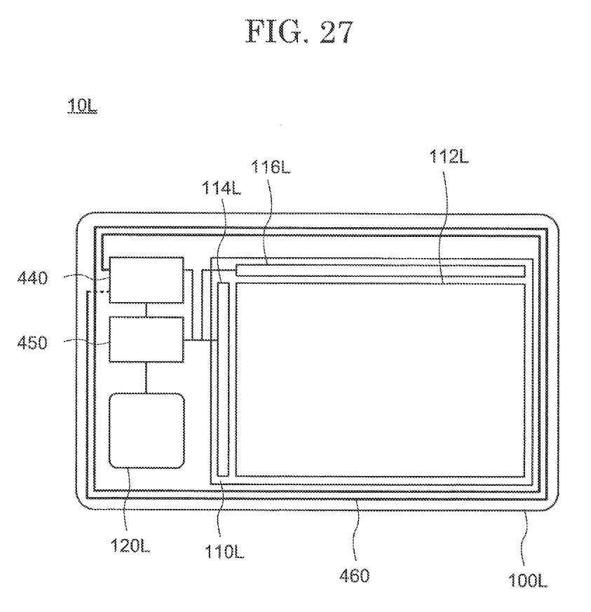

A summary of a card type device related to one embodiment of the present invention is explained using FIG. 27 to FIG. 30. In the ninth embodiment, a card type device 10L which can supply power or send and receive data by wireless communication with external devices is explained.

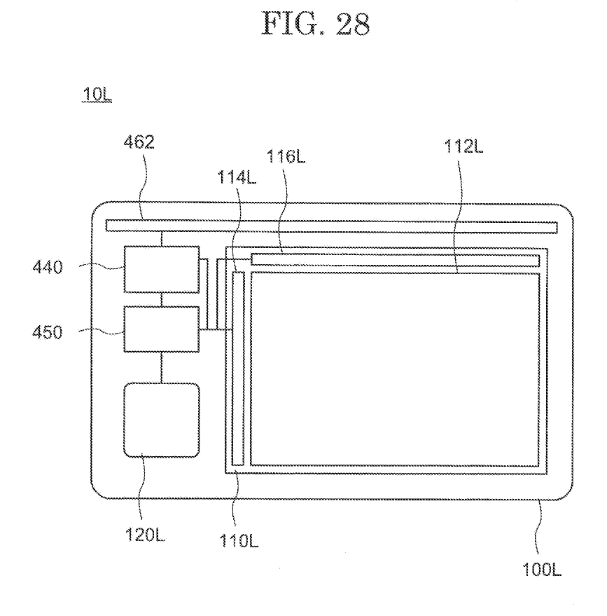

FIG. 27 is a planar view diagram showing a structure of a card type device related to one embodiment of the present invention. As is shown in FIG. 27, a display 110L, IC chip 120L, power supply circuit 440, communication circuit 450 and an antenna 460 are arranged on a card 400L. The antenna 460 is connected to the power supply circuit 440. The communication circuit 450 is connected to the power supply circuit 440. The power supply circuit 440 and communication circuit 450 are connected to a gate driver circuit 114L and a data driver circuit 116L. Although an electromagnetic induction type antenna used with respect to 13.56 MHz band (HF band) radio waves is exemplified in FIG. 27 for example, a radio wave type antenna 462 used with respect to 2.45 GHz band or 950 MHz band (UHF band) radio waves may be used as is shown in FIG. 28. The antennas 460, 462 described above may be formed using a conductive layer which forms the display 110L.

The power supply circuit 440 supplies power sent from an external device to the card type device 10L. The power sent from the external device is received by the antenna 460 and a constant voltage is generated when the power is rectified by the power supply circuit 440. The power supply circuit 440 is described in detail herein. The communication circuit 450 receives a modulation signal sent from an external device via a radio wave which is a medium of communication, and extracts a command signal by analyzing the modulation signal. The communication circuit 450 sends data of the card type device 10L via radio waves. The communication circuit 450 displays data in the display 110L according to the sent command signal.

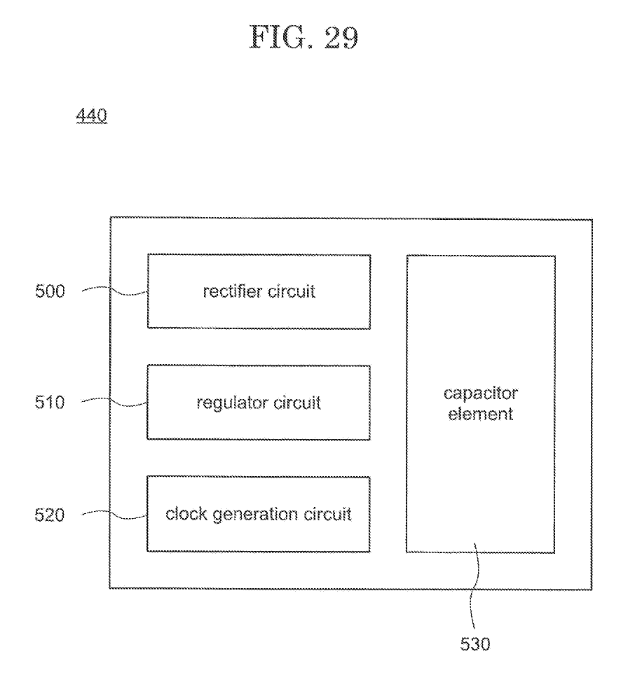

FIG. 29 is a block diagram showing a functional structure of a power supply circuit of a card type device related to one embodiment of the present invention. As is shown in FIG. 29, the power supply circuit 440 of the card type device 10L includes a rectifier circuit 500, regulator circuit 510, clock generation circuit 520 and a capacitor element 530.

The rectifier circuit 500 is a circuit for flowing a current in one direction and converts an alternating current to a direct current. The rectifier circuit 500 converts radio waves which are a communication medium to a direct current voltage from an alternating current voltage. The regulator circuit 510 generates a constant voltage based on the direct current voltage converted by the rectifier circuit 500. The rectifier circuit 500 generates two types of constant voltage, a drive voltage of the communication circuit 450 and a drive voltage of the display 110L. However, one type of constant voltage is generated in the case where the drive voltages of the communication circuit 450 and the display 10L are the same. The clock generation circuit 520 generates a clock necessary for driving each circuit based on an alternating current voltage before being rectified by the rectifier circuit 500.

The capacitor element 530 holds power supplied from the power supply circuit 440. Specifically, the capacitor element 530 holds (charges) a charge based on a constant voltage generated by the regulator circuit 510. The capacitor element 530 may also be charged based on a direct current voltage converted by the rectifier circuit 500. The capacitor element 530 is formed by any layer among a plurality of layers which form the display 110L. For example, in the case where a transistor included in the display 110L has a conductive semiconductor layer, a gate insulation layer and a gate electrode, the capacitor element 530 may be a capacitor element in which the conductive semiconductor layer and gate insulation layer are a pair of electrodes and the gate insulation layer sandwiched therebetween is a dielectric. In the case where the transistor includes a gate electrode, an interlayer insulation layer and a source/drain electrode, the capacitor element 530 may be a capacitor element in which the gate electrode and the source/drain electrode are a pair of electrodes and the interlayer insulation layer sandwiched therebetween is a dielectric.

Although a structure in which power is supplied by an electromagnetic method or radio wave method was exemplified above, the present invention is not limited to this structure. For example, power may also be supplied using a resonance method or an electric field coupling method.

### [Operation Flow of Card Type Device 10L]

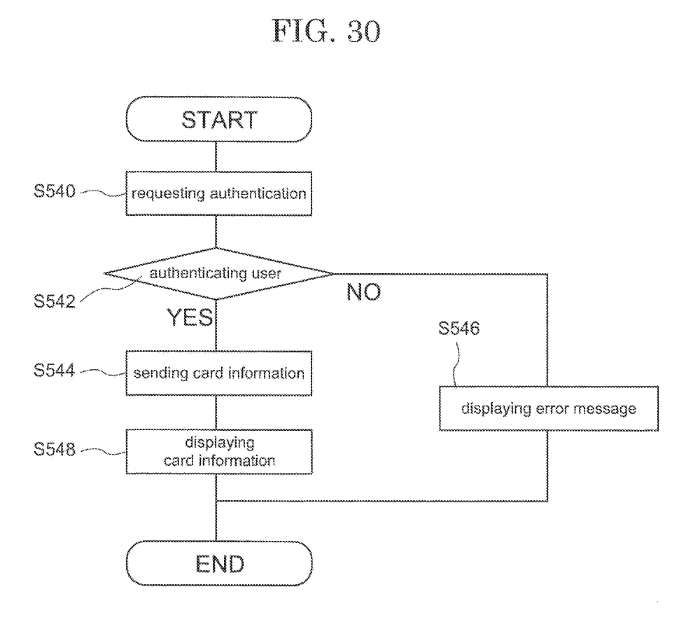

FIG. 30 is a flowchart showing the operation of a card type device related to one embodiment of the present invention. In FIG. 30, the operation of the card type device 10L shown in FIG. 27 and FIG. 28 is explained in detail using a flowchart. As an example of the operation of the card type device 10L, a method is explained in which a user communicates with a communication reader/writer (R/W) using the card type device 10L and a one-time password (OTP) is received from the R/W and displayed.

First, an authentication request is performed using the card type device 10L (step S540). The authentication request is performed by holding the card type device 10L to the R/W. When the R/W receives the authentication request, the R/W sends a command requesting unique data of the card type device 10L. The card type device 10L returns device unique data of the card type device 10L to the R/W in response to the requested command. By this operation, the R/W uniquely identifies the card type device 10L.

Next, the R/W sends a command signal to the card type device 10L instructing individual authentication of the user. The method shown in the second embodiment (FIG. 4 to FIG. 10) for example can be used as the method for individual authentication of the user. Authentication of the user may also be performed by comparing the device unique data of the card type device 10L with data used for individual authentication of the user.

When authentication of the user is successful ([YES] in step S542), OTP data is sent from the R/W to the card type device 10L (step S544). When authentication of the user fails ([NO] in step S542), an error message is displayed in the card type device 10L (step S546) and the operation is terminated.

When the card type device 10L receives OTP data sent from the R/W, the OTP data is displayed in the display 110L of the card type device 10L (step S548). The user can login to a predetermined service based on the displayed OTP data.

The R/W may perform the operations described above alone or after receiving instructions from a server in which the R/W is registered. For example, a smart phone, tablet PC, note PC or desktop PC including a near field radio communication (NFC) function may be used as the R/W described above. The R/W may also send an authentication request received from the card type device 10L to a server and send a command signal received from the server to the card type device 10L.

As described above, according to the card type device 10L related to the ninth embodiment, since it is possible to perform wireless communication with external devices, it is possible to display various data on a display in response to a command signal from an external device.

The OTP data displayed using the method of the ninth embodiment described above may be deleted from a screen using the method of the fourth embodiment. For example, display of the OTP may be deleted by a user bending the card type device 10L after the OTP is displayed.

### Tenth Embodiment

### [Structure of Card Type Device 10M]

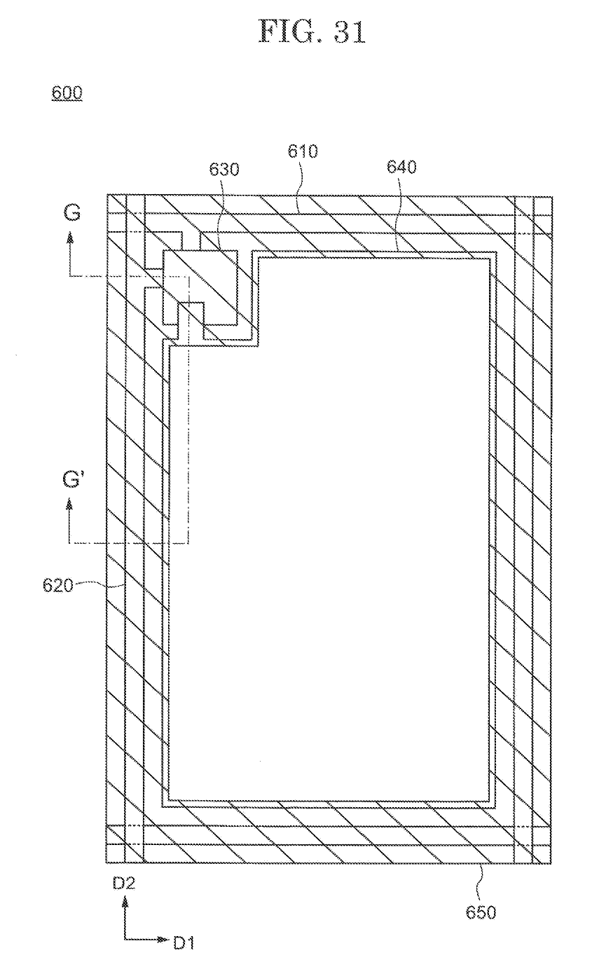

A summary of a card type device related to one embodiment of the present invention is explained using FIG. 31 to FIG. 36. In the tenth embodiment, card type device 10M which has a transparent display is explained. Since the structure of the card type device 10M related to the tenth embodiment is the same as the card type device 10 shown in FIG. 1 and FIG. 2, an explanation is omitted and instead FIG. 1 and FIG. 2 are referred to. When the card type device 10M related to the tenth embodiment and the card type device 10 related to the first embodiment are compared, both devices have different pixel structures. These pixels are arranged in a matrix shape in a display region of the display. Therefore, the structure of a unit pixel of the card type device 10M is explained in detail below.

FIG. 31 is a planar view diagram showing a unit pixel layout in a display region of a card type device related to one embodiment of the present invention. As is shown in FIG. 31, a unit pixel 600 of the card type device 10M includes a gate line 610, a data line 620, a transistor 630, a pixel electrode 640 and a light blocking member 650. A region in which the light blocking member 650 is not arranged can be viewed from both the front and rear surfaces of the card type device 10M.

The gate line 610 extends in a row direction (direction D1) of a pixel arranged in a matrix shape in a display region. The data line 620 extends in a column direction (direction D2) of a pixel arranged in a matrix shape. The gate line 610 and data line 620 mutually intersect at a right angle to each other, and the transistor 630 is arranged near an intersection point of the two lines. The transistor 630 is connected to the gate line 610 and the data line 620. The pixel electrode 640 is connected to the transistor 630. The light blocking member 650 is opened so as to expose the pixel electrode 640. That is, the light blocking member 650 covers the gate line 610, data line 620 and transistor 630.

Although a layout is exemplified in FIG. 31 in which the gate line 610 and data line 620 are straight lines and mutually intersect at a right angle to each other, the present invention is not limited to this layout. For example, one or both of the gate line 610 and data line 620 may also extend in the direction D1 and direction D2 while bending. The gate line 610 and data line 620 may also intersect each other at an angle other than a right angle.

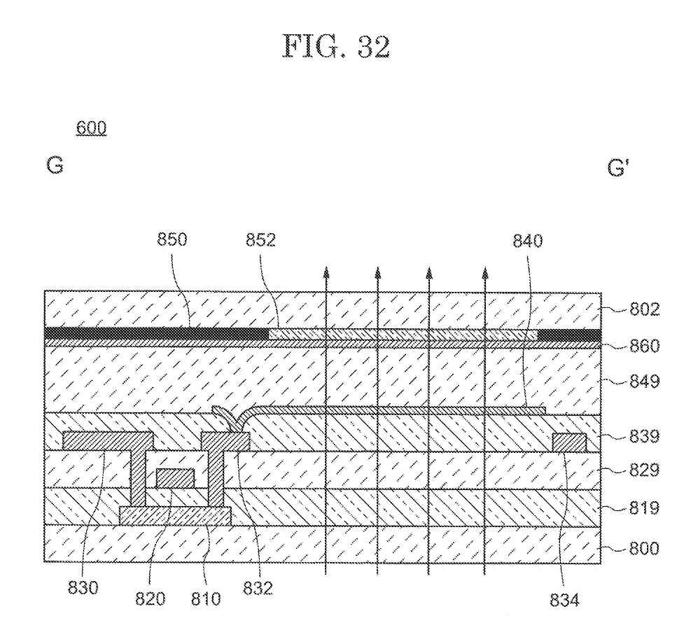

FIG. 32 is cross-sectional diagram along the line G-G′ of a unit pixel layout in a display region of a card type device related to one embodiment of the present invention. As is shown in FIG. 32, the unit pixel 600 includes an array substrate 800 and an opposing substrate 802. A semiconductor layer 810, gate insulation layer 819, gate electrode 820, first insulation layer 829, source electrode 830, drain electrode 832, data line 834, second insulation layer 839, pixel electrode 840, liquid crystal layer 849, light blocking member 850, color filter 852 and common electrode 860 are arranged between the array substrate 800 and opposing substrate 802.

The semiconductor layer 810 is arranged above the array substrate 800. The gate insulation layer 819 is arranged above the semiconductor layer 810. The gate electrode 820 is arranged above the gate insulation layer 819. The first insulation layer 829 is arranged above the gate electrode 820. The source electrode 830, drain electrode 832 and data line 834 are arranged above the first insulation layer 829 and connected to the semiconductor layer 810 via an opening part arranged in the first insulation layer 829. The second insulation layer 839 is arranged above the source electrode 830, the drain electrode 832 and the data line 834. The pixel electrode 840 is arranged above the second insulation layer 839 and is connected to the drain electrode 832 via an opening part arranged in the second insulation layer 839. A transparent conductive layer is used for the pixel electrode 840 and common electrode 860.

The light blocking member 850 and color filter 852 are arranged above the opposing substrate 802. As described above, the light blocking member 850 is arranged above the semiconductor layer 810, gate electrode 820, source electrode 830, drain electrode 832 and data line 834. The color filter 852 is arranged in a region opened by the light blocking member 850. The common electrode 860 is arranged above the light blocking member 850 and the color filter 852. A region arranged with the color filter 852 is a pixel corresponding to the color of the color filter.

The liquid crystal layer 849 is arranged between the array substrate 800 and the opposing substrate 802. An alignment film for controlling the alignment of liquid crystal molecules may also be arranged between the pixel electrode 840 and liquid crystal layer 849 and between the common electrode 860 and liquid crystal layer 849.

As is shown in FIG. 32, apart from the pixel electrode 840 and common electrode 860, only a substrate or insulation layer is arranged in a region in which the color filter 852 is arranged. In other words, a layer including light blocking properties and a backlight are not arranged in a region opened by the light blocking member 850 in a planar view. That is, the unit pixel 600 can be viewed from both the array substrate 800 side and opposing substrate 802 side. In this case, viewing is improved if an external device is prepared, a card type device is arranged above the external device and the external device is made to emit light. If the external device is mounted with a liquid crystal display such as a smartphone, polarized light is already irradiated. Therefore, only one polarization plate is required in the case of a card type device mounted with a liquid crystal display.

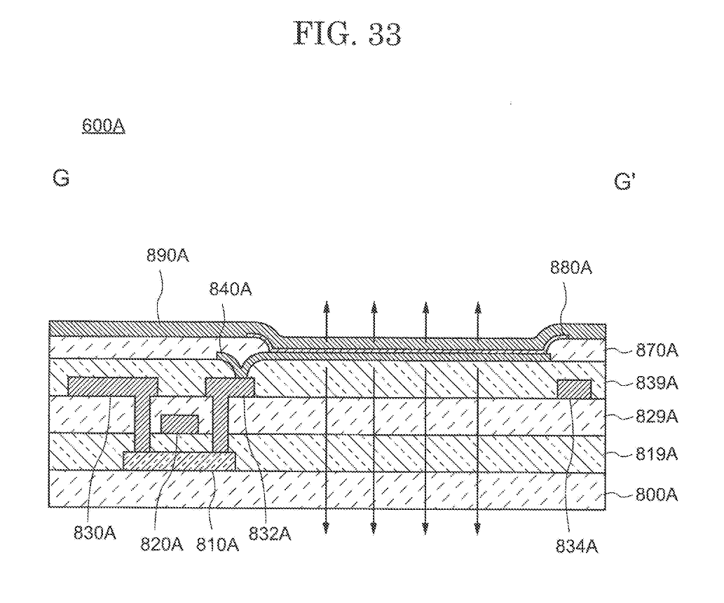

FIG. 33 is a cross-sectional diagram along the line G-G′ of a unit pixel layout in a display region of a card type device related to a modified example of one embodiment of the present invention. Although the cross-sectional structure of the unit pixel 600A shown in FIG. 33 is similar to the cross-sectional structure of the unit pixel 600 shown in FIG. 32, the structure above the pixel electrode 840A in the unit pixel 600A is different to the unit pixel 600. An explanation of the same structure as FIG. 32 is omitted and only the different points are explained.

As is shown in FIG. 33, the unit pixel 600A includes a bank 870A, light emitting layer 880A and common electrode 890A above a pixel electrode 840A. A transparent conductive layer is used for the pixel electrode 840A and common electrode 890A. A potential difference is supplied between the pixel electrode 840A and common electrode 890A, and the light emitting layer 880A emits light by flowing a current to the light emitting layer 880A. In other words, the light emitting layer 880A in a region which contacts with both the pixel electrode 840A and common electrode 890A emits light. Different materials may be used for the light emitting layer 880A according to the color of a pixel.

As is shown in FIG. 33, apart from the pixel electrode 840A and common electrode 860A, only a substrate or insulation layer is arranged in a light emitting region of the light emitting layer 880A. In other words, a layer including light blocking properties is not arranged in a region opened by the light blocking member 850A. That is, the unit pixel 600A can be viewed from both the array substrate 800A side and opposing substrate 802A side.

### [Application Example of Card Type Device 10M]

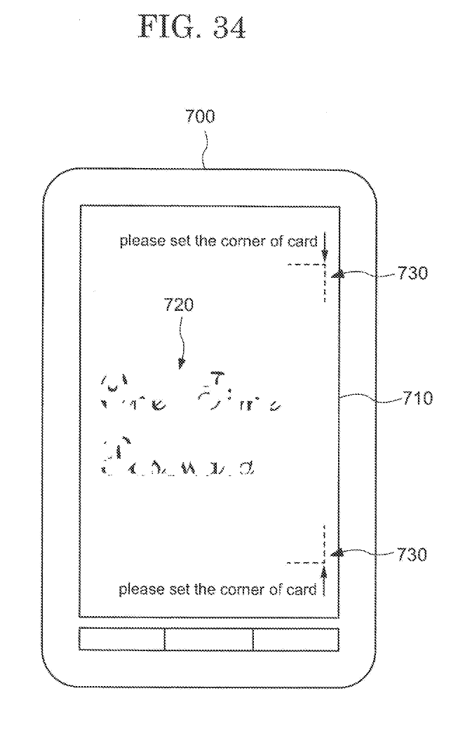

An application example of the card type device 10M using the transparent display described above is explained using FIG. 34 to FIG. 36. FIG. 34 to FIG. 36 are diagrams showing an application example of a card type device related to one embodiment of the present invention. In this application example, separate images are displayed respectively in the card type device 10M and an image displayed in another communication terminal 700, and certain specific data is obtained by overlapping these images.

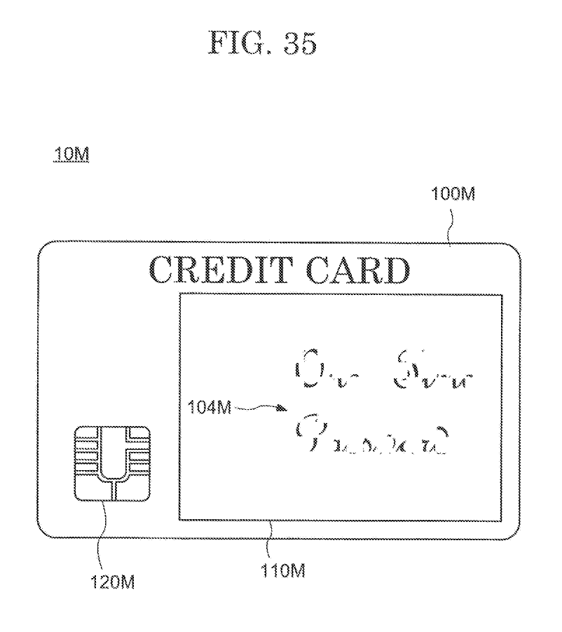

A first image 720 and a guide 730 are displayed in the display 710 of the communication terminal 700 shown in FIG. 34. The first image 720 is displayed with characters or numerals that cannot be recognized alone. A second image 104M is displayed in the display 110M of the card type device 10M shown in FIG. 35. The second image 104M is also displayed with characters or numerals that cannot be recognized alone the same as the first image 720. The display 110M is a transparent display and can be viewed through an image of the background of the card type device 10M.

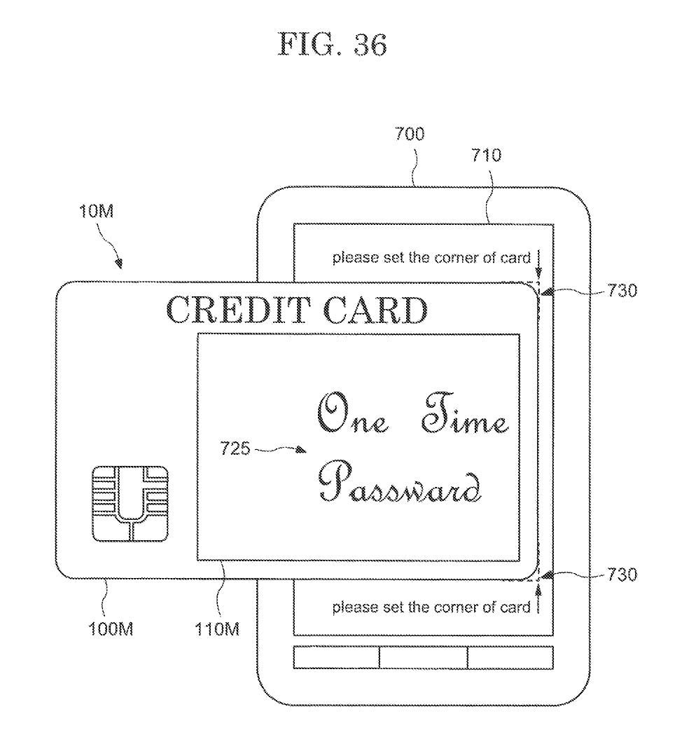

As is shown in FIG. 36, by aligning and overlapping a corner of the card type device 10M with the guide 730 of the communication terminal 700, the second image 104M displayed in the display 110M and the first image 720 of the display 710 displayed in the background of the display 110M are overlapped and displayed. In this way, it is possible to view characters and numerals 725 which are recognizable.

The case where a login request is made to a certain service using the communication terminal 700 and an OTP required to login is received from the service server is explained as the application example described above. First, when the communication terminal 700 requests a login, first image data is received from the service server and the first image 720 is displayed in the display 710. Next, communication with the card type device 10M is carried out using NFC arranged in the communication terminal 700, authentication of a user is performed in the card type device 10M, and the second image 104M is displayed in the display 110M of the card type device 10M. In addition, by overlapping the communication terminal 700 with the card type device 10M, the recognizable characters or numerals 725 (one time password) are obtained.

As described above, according to the card type device 10M related to the tenth embodiment, it is possible to obtain an image using background light by using a transparent display 110M in the card type device 10M. According to the application example described above, a login system with a higher level of security is realized.

### Eleventh Embodiment

### [Structure of Card Type Device 10N]

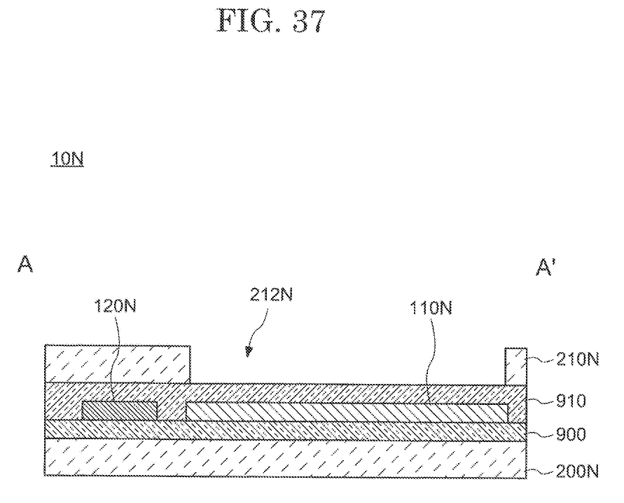

A summary of a card type device related to one embodiment of the present invention is explained using FIG. 37. In the eleventh embodiment, a card type device 10N in which a display 110N is enclosed by a layer including moisture proof properties is explained. Since the structure of the card type device 10N related to the eleventh embodiment is the same as the card type device 10 shown in FIG. 1 and FIG. 2, an explanation is omitted here and FIG. 1 and FIG. 2 are referred to.

FIG. 37 is a cross-sectional diagram along the line A-A′ of a card type device related to one embodiment of the present invention. As is shown in FIG. 37, the card type device 10N includes a first base 200N, a second base 210N, a display 110N, an IC chip 120N, a first protection layer 900 and a second protection layer 910. Although the card type device 10N shown in FIG. 37 is similar to the card type device 10 shown in FIG. 3A, the card type device 10N is different from the card type device 10 in that the display 110N and IC chip 120N are enclosed by the first protection layer 900 and second protection layer 910. In other words, a bottom surface of the display 110N and a bottom surface of the IC chip 120N are covered by the first protection layer 900, and a side surface and upper surface of the display 110N and a side surface and upper surface of the IC chip 120N are covered by the second protection layer 910.

The first protection layer 900 and second protection layer 910 are resin layers, and permeability to water of the first protection layer 900 and second protection layer 910 is respectively lower than permeability to water of the first base 200N and second base 210N. For example, it is possible to use a material in which multiple layers of a silicon, acrylic or epoxy based resin are overlapped as the first protection layer 900 and second protection layer 910. It is possible to use a layer having permeability to water of 0.1/m²/day or less for each of the first protection layer 900 and second protection layer 910 respectively.

As described above, according to the card type device 10N related to the eleventh embodiment, water is suppressed from reaching the display 110N by enclosing the display 110N with a first insulation layer 900 and second insulation layer 910 having a lower permeability to water than each of the first base 200N and second base 210N. Therefore, the card type device 10N including the display 110N with a high level of reliability is provided.

Furthermore, the present invention is not limited to the embodiments described above and appropriate modifications within a scope that does not depart from the concept of the present invention are possible.

What is claimed is:

1. A card type device comprising:
a base having flexibility; and
a display having flexibility arranged on the base.

2. The card type device according to claim 1, further comprising:
a first touch sensor arranged on a first surface of the base or the display;
a second touch sensor arranged on a second surface of the base or the display, the second surface being on the opposite side of the first surface; and
a control circuit connected to the first touch sensor and the second touch sensor;
wherein
the control circuit receives a first detection signal from the first touch sensor, receives a second detection signal from the second touch sensor, and performs authentication of a user using the first detection signal and the second detection signal.

3. The card type device according to claim 2, wherein the control circuit performs authentication of the user by simultaneously detecting the first detection signal and the second detection signal.

4. The card type device according to claim 1, further comprising:
a sensor arranged on the base and configured to detect a change in shape of the base; and
a control circuit connected to the sensor;
wherein
the control circuit receives a detection signal from the sensor, and controls an operation of the display based on the detection signal.

5. The card type device according to claim 4, wherein the sensor is a piezoelectric element or an optical sensor, the piezoelectric element or the optical sensor detecting a change in shape of the base and the control circuit re-writing a screen image of the display in the case where the change in shape is detected.

6. The card type device according to claim 1, wherein the display includes a first display region and a second display region, a pixel pitch interval of the second display region being wider compared to a pixel pitch interval of the first display region.

7. The card type device according to claim 6, wherein the display further includes a first data driver connected to pixels of the first display region via a plurality of first data lines, and a second data driver connected to pixels of the second display region via a plurality of second data lines, an interval between the plurality of second data lines being wider than an interval between the plurality of first data lines.

8. The card type device according to claim 7, wherein the display switches between a first display mode capable of supplying different image data, and a second display mode supplying the same image data with respect to two first data lines connected to adjacent same color sub-pixels among the plurality of first data lines.

9. The card type device according to claim 1, further comprising:
a storage part configured to store data using magnetism;
wherein
the storage part is arranged between two layers, the two layers being included in the display.

10. The card type device according to claim 9, further comprising:
a protection component configured to cover a region overlapping the storage part in a planar view.

11. The card type device according to claim 1, further comprising:
a power supply circuit configured to supply power sent from an external device.

12. The card type device according to claim 11, further comprising:
a capacitor element including the same layers as a plurality of layers included in the display and the capacitor element configured to hold a charge supplied from the power supply circuit.

13. The card type device according to claim 1, further comprising:
a communication circuit configured to send and receive data by communicating with an external device.

14. The card type device according to claim 1, wherein the display is a transparent display.

15. The card type device according to claim 1, further comprising:
a resin layer having low water permeability compared to a material forming the base and configured to cover the display between the base and the display.

16. The card type device according to claim 2, further comprising:
a sensor arranged on the base and configured to detect a change in shape of the base; and
a control circuit connected to the sensor;
wherein
the control circuit receives a detection signal from the sensor, and controls operation of the display based on the detection signal.

17. The card type device according to claim 3, further comprising:
a sensor arranged on the base and configured to detect a change in shape of the base; and
a control circuit connected to the sensor;
wherein
the control circuit receives a detection signal from the sensor, and controls operation of the display based on the detection signal.

18. The card type device according to claim 2, wherein the display includes a first display region and a second display region, a pixel pitch interval of the second display region being wider compared to a pixel pitch interval of the first display region.

19. The card type device according to claim 3, wherein the display includes a first display region and a second display region, a pixel pitch interval of the second display region being wider compared to a pixel pitch interval of the first display region.

20. The card type device according to claim 2, further comprising:
a storage part and configured to store data using magnetism;
wherein
the storage part is arranged between two layers, the two layers being included in the display.
